(19) United States
(12) Patent Application Publication
(10) Pub. No.: US 2005/0010522 A1
(43) Pub. Date: Jan. 13, 2005

(54) Management system for open position with indication for loss cut and held stock management system with indication for loss cut

(75) Inventor: Hiroshi Kusu, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FINALABO CO., LTD., Tokyo (JP)

(21) Appl. No.: 10/886,797

(22) Filed: Jul. 9, 2004

(30) Foreign Application Priority Data
Jul. 10, 2003 (JP) 2003-272720
Dec. 26, 2003 (JP) 2003-432317
Mar. 18, 2004 (JP) 2004-078027
Mar. 31, 2004 (JP) 2004-105491

(51) Int. Cl. G06F 17/60

(52) U.S. Cl. 705/37

(57) ABSTRACT

On the basis of trading information shared by a securities company and a customer executing margin trading with the securities company, all positions or stocks in a customer account are managed to automatically execute a first loss cut at a first loss cut rate for selling the stocks or the like at the market and a second loss cut rate for selling the stocks and the like outside the market to execute the loss cut evenly for each open position in the customer account by the specified first and second rates. Indication of execution of the loss cut is provided to the customer. Specified individual open positions in the customer account may be managed to automatically execute the loss cut. This system can be used in cash trading for held stocks.

### FIELD OF THE INVENTION

This invention relates to a management system for managing an open position with an indication for a loss cut and a held stock management system for managing a held stock with an indication for a loss cut and particularly to a management system for an open position with a loss cut using a computer system and a held stock management system with a loss cut using a computer system.

### BACKGROUND OF THE INVENTION

In margin trading in buying and selling stocks using a loan provided to a customer by a finance facility including a securities company, a stock trading system and a method of trading stocks, capable of reducing a risk due to decrease in a stock price, are known, wherein profits and losses between the customer and the securities company are adjusted. For example, Japanese laid open patent application No. 2002-92328 discloses a stock trading system and a method of trading stocks comprising a securities company, a customer terminal, and the Internet. The securities company includes storing means for storing the amount of the loan to a customer, calculation means for calculating the interest on the loan, calculation means for calculating a market capitalization of stocks held by the customer, calculation means for calculating a profit and loss from the market capitalization, an amount of loan, and the interest, calculation means for calculating a maintenance rate of the stocks from the profit and loss and the market capitalization, a storing means for storing a threshold value of the maintenance rate of the stocks, and indication means for indicating the information when the maintenance rate is equal to or greater than the specified threshold value.

These stock trading system and method of trading stocks output an alarm for prompting the closing out of an open position and/or for acting closing out for the customer when the maintenance rate reaches the specified threshold value (loanable value) due to decrease in the stock price of the issue and/or increase in the interest.

If the notifying is limited to the alarm, the system supplies an instruction to interesting parties including the securities company and the agency specified by the securities company (hereinafter referred to as a securities company and the like) and the customer. When proxy execution is requested, the securities company or the like performs the closing out for the customer as a proxy for the customer.

As described above, the indication that the maintenance rate reaches the threshold value, namely, alarming, provides a rapid closing out for the open position, for example, by reselling the stocks. Thus, this system monitors the specified consignment guarantee maintenance rate of the open position for the customer day and night. When the alarm indicating that the guarantee money maintenance rate reaches the threshold value is executed, the securities company tries to suppress the risk by the rapid closing out.

A term “maintenance rate” used in the description of background of the invention is a rate of an estimated value to the market capitalization of the stock. The term “maintenance rate” will be described below in the concept of the known “loanable value” about the case using an equation representing the maintenance rate increasing when a profit and loss condition becomes worse, wherein the profit and loss condition includes the amount of the consignment guarantee money, the buying price, the amount of loan, the interest of the loan, and the market capitalization of the stocks. In this case, the maintenance rate is obtained by dividing the total of loan (interest and principle of the loan amount) by the market capitalization.

Thus, this management system, viewed from the securities company to one customer, integrally manages the asset only by the total of the margin trading with the securities company and manages each open position without a distinctive manner or multiple-evaluations with respect to the unrealized profits and losses.

To determine whether the closing out is to be executed, the maintenance rate corresponding to the transaction of the customer is calculated with the total amount of loan and the stock price information by a maintenance rate calculation equation. For example, when the maintenance rate becomes equal to or greater than 100%, a buying indication is made. Further, there may be a contract to buy the stocks from the customer by the securities company or a third party specified by the securities company. This limits a loss of the customer within the consignment guarantee money, preventing a loss over the total amount of the consignment guarantee money.

Further, if a threshold value for the maintenance rate is set to a value less than 100%, the amount of the maximum loss can be limited within the total of the consignment guarantee money. Thus, the securities company can collect the loaned money from the exit price by prompting the customer to sell the stocks.

From the above, the maintenance rate is also referred to as a guarantee money maintenance rate and may have an inverse relation in accordance with the definition. For example, at the background of the specification, it is called the maintenance rate, wherein the calculation value increases with worse in the profit and loss condition. When the maintenance rate=100%, this means that the subtraction of the unrealized profit and loss from the consignment guarantee money cancels the remaining of the consignment guarantee money. On the other hand, in the description of the invention of the specification, this is differently defined as (consignment guarantee money) maintenance rate β=0%.

Further, the compulsory reverse trade, in margin trading, of a customer's open position executed by the securities company within the recent general service is done as a countermeasure against default by the customer to the securities company. This means that the securities company desires to collect not all the bond for the margin trading, but collect it to a certain extent. Thus, this was executed independently of a difference between the stock having profit and the stock having loss.

The above described compulsory reverse trade is, with respect to whose profit is to be protected, not for the customer but for the securities company to keep a profit thereof. This is because the consignment guarantee money or the additional consignment guarantee money is collateral collected from the customer to protect the profit at the security company.

Further, the management system using the maintenance rate is provided in order to take a risk by the securities company side instead of the customer in addition to collecting the loan from the customer by the securities company. In other words, it is provided to keep balance between the customer existing at a disadvantage side and the securities company dominating over the customer in all respects including financial surplus, an information collection ability and a risk hedging ability, by legally receiving the loss of the customer greater than the total of the consignment guarantee money.

In addition, there is a service manner called “stop order” or “stop loss order” (hereinafter referred to as stop order and the like) provided particularly in the Internet trading to reduce the loss in the stock investment by the customer itself.

“Stop order or the like” is an order in such a condition that the held stocks are sold at y yen less than x yen when the stock price is not greater than x yen. This is an option of the customer to prevent the loss from expanding by an instruction to sell the stocks at a certain stock price before a large decrease in the stock price when the stock price of the specified stocks begins to decrease.

However, “Stop order or the like” may show two important problems against the original object of “loss cut”.

One is a failure in the loss cut due to illusion. For example, it is assumed that an individual investor has more than one set of stocks having different prices. The investor is deluded by the unrealized profit in the blue-chip stocks and thus, the investor eases the judgment for the loss cut for the stocks of which loss is now expanding. That is, there is a tendency to avoid the acceptance of the actual unrealized loss in investors. This disturbs the judgment for loss cut, so that the settings of stop order intentionally provided would be released by its own intention, which results in the failure in the loss cut by illusion.

The failure in the loss cut due to illusion may be caused by the optional decision by the customer. Further, the stop order for the trading is also optional. Thus, there is a problem that the setting of the stop order is optionally executed for each stock.

In other words, the customer can set, change, or release the “stop order” at will. This will result in a failure in the loss cut due to delusion.

Another problem is in that though a trading order is made to execute the “loss cut”, the expansion of the loss may continue because the “loss cut” cannot be executed due to the absence of a buying party in the market. The “stop order” is only an order of a trade at a predetermined stock price irrespective of whether the original object of “loss cut” is achieved or not. For example, the stock order is executed such that the held stocks are sold at y yen equal to or smaller than x yen when the stock price is not greater than x yen. Thus, the “loss cut” is not always achieved by the “stop order”.

There are various types of conventional risk-limited stock trading having the concept of the above-mentioned “maintenance rate” and further having the concept of “consignment guarantee money maintenance rate” representing a remaining rate of consignment guarantee money corresponding to the collateral value. However, such a managing method for limiting a risk in accordance with the total guarantee money maintenance rate did not adopt a “short sale”. Thus, there is no management system for limiting a risk in any trading condition.

The margin trading is useful for individual investors. However, because individual investors tend to fall into wishful thinking at a risk, it is difficult for an individual investor to execute the “loss cut” at its own will.

Further, cash trading is frequently executed for long-term investment. Thus, individual investors tend to neglect the instantaneous decrease in the stock price. Still further, there is a possibility that the company that issued the stocks may crash due to a severe circumstance change during the long stock holding term.

Generally, the “loss cut” is conveniently used in the margin trading (generally, short-term investment) to limit risk. However, there is a trend of a constant deflation and thus, in the current circumstance, the stock price of a stable stock to be held for a long term may also gradually decrease, so that the stock becomes frozen. In this case, if such stocks are sold, the loss would be realized, so that the customer cannot sell them.

As described above, in the cash trading for a long term investment, the risk management at the investor is blunt in the instantaneous decrease and the long-term decrease in the stock price, so that investor may tend to lose the chance for the “loss cut”.

There are two types of “loss cut” for the held stocks in an account of the investor toward the margin trading and cash trading.

The first “loss cut” is “total loss cut” for finally collecting the bond for the securities company by the intention of the securities company irrespective of difference between blue chip stocks having an unrealized profit and subordinated stocks having an unrealized loss. Thus the securities company clears the account to collect the loaned stocks and the loaned money. Generally, the “total loss cut” is executed after several days from the final notification.

The second “loss cut” is “individual loss cut” without the final notice to clear the corresponding account. Thus, the second loss cut is executed of customer's own will only for subordinate stocks having an unrealized loss sharing a part of the account of the investor to keep its own profit when a small unrealized loss occurs before a large decrease in the stock price.

As mentioned above, it is difficult for the individual investor to acquire a reasonable management for reducing losses of all individual stocks though the investor desires so.

Further, if a customer orders the securities company to execute the second loss cut, the securities company cannot precisely trace a variation of each stock price and thus cannot ensure the execution of the second loss cut. This is because the first “loss cut” is a total loss cut which is capable of total process with the computer of the securities company irrespective of the blue chip stocks and subordinate stocks having an unrealized loss. On the other hand, the second loss cut requires individual judgment for each open position or each stock in the customer account by tracing each stock price for immediate individual decision.

The operation of the conventional managing method will be described with reference to FIG. 2. In the conventional managing method for integrally managing the total of unrealized profit and loss, when the total of profits and losses decreases, for example, to −20% because the prices of stocks C and E largely decrease (chained lines), the securities company sells all stocks A to F.

Particularly, according to the conventional method disclosed in Japanese laid open patent application No. 2002-92328, if the same issue of the stocks A to F are bought on different dates at different rates and maintained as a plurality of open positions, all stocks are sold until the total profits and losses of the stocks A to F become −20% deficit. Thus, this management system only guarantees the refund for the total loaned amount if the securities company loans the money for buying the stocks.

As described above, it is difficult to automatically execute the loss cut for each stock (each open position) before such a variation in the stock price that the unrealized loss is expanding. Thus, the securities company is required to hold many operators to watch the variations to execute the second loss cut.

As mentioned above, the first loss cut provides a management system for the total loss cut to ensure the refund of the total money loaned from the securities company to the customer.

On the other hand, the second loss cut requires the excessive man power of the securities company.

Further, when the execution of the second loss cut is required, if there is no buying party in the market, the actual stop loss cannot be done.

### SUMMARY OF THE INVENTION

According to a first aspect of the present invention provides a management system capable of automatic closing out for a loss cut for each stock or each open position with indication of the loss cut executed at a specified rate of profit and loss value to the customer to suppress the risk at the customer accompanied with margin trading.

According to a second aspect of the present invention, there is provided a management system comprising: defining means for defining an open position to be compulsorily closed out in accordance with a specified profit and loss calculation value out of trading information shared with a customer with which a securities company executes margin trading including loaning money and stocks and buying and selling stocks using credit accommodation; transaction content storing means for storing transaction content; stock information collecting means for collecting a renewed stock price; display means for displaying the open position to be compulsorily closed out and at least one of a stock price of compulsory reverse trading at a market executed by the securities company and a stock price of the compulsory reverse trading executed outside the market with a partner including one of the securities company and a party specified by the securities company at a display frame capable of integrally displaying a plurality of open positions at a unit as long as the stocks of the open positions have the same issue, the same trading date, and the same trading price, in order to execute, instead of the customer, an automatic loss cut, requested by the customer, for each open position; and a function for executing the loss cut at a specified rate for each open position at a customer account.

This system may calculate the profit and loss calculation value for determining whether an open position is to be closed out at a minimum unit of the open positions of the same issue traded at the same day and at the same price.

For example, when the date, the stock price, and other conditions are renewed, the profit and loss calculation value is renewed and monitored to be compared with a threshold value to execute the closing out. The customer and the securities company agree in the threshold value to provide the automatic closing out for each open position before execution of trading to exclude customer's intention or feelings. The customer can be provided with this service only by inputting the agreement key operation through the Internet. Here, the open position means the stock that has a buying and selling contract with a securities exchange or a securities company, but has not been settled to terminate the trading relation by buying back or resale.

“Closing out” means the termination of a trading relation by settlement by reselling or buying back of the open position. On the other hand, “cash trading” (not a margin trading) is called selling to discriminate it from the open position.

The closing out may be executed when the profit and loss calculation value set for each open interest reaches its threshold value. This limits the customer's profit and loss within the risk corresponding to the set threshold value. In other words, the threshold value may be set to limit the risk.

This operation may provide the closing out only for open positions having a low investment performance by the securities company or the like under monitoring by the securities company.

The profit and loss may be calculated by an equation mentioned later. The calculation, displaying, instruction, and execution for the closing out provides a heavy load to the securities company if this operation would be done manually because there may be many open positions, and the profit and loss calculation value varies with the variation of the current stock price. This computer system may provide the automatic closing out for the loss cut for each open position to exclude the customer's or the employee's intention or feelings in management of the open position.

Further, in the calculation of the above-described equation, if a different threshold value for the unrealized profit and loss is set for each open position, the management for a lot of open positions exceeds the abilities of memory and the power of attention, so that the management system for open positions is required to automatically close out the extracted managed open position without the customer's feeling.

Therefore, there may be provided the computer system including such information processing function for automatically closing out the extracted managed open position without the customer's feeling.

Further, in the calculation of above-described equation, if a different threshold value for the unrealized profit and loss is set for each open position, the management for a lot of open positions exceeds the abilities of memory and the power of attention, so that the management system for open positions is required to automatically close out the extracted managed open position without the customer's feeling.

Therefore, the computer system including such information processing function is provided.

According to a third aspect of the present invention, the margin trading includes short selling.

According to this structure, if the stock price of the open position short-sold on the basis of the forecast of increase in the stock price increases with missing the forecast, this system may have a high risk reduction efficient because in such a case, the stock price has no upper limit, so that there is a danger of occurrence of infinite loss.

According to a fourth aspect of the present invention, the management system comprises: an interface for directly and indirectly transmitting and receiving information to and from a back office computer system, at the securities company, for executing actual transactions at the market; and closing out instruction means for transmitting a closing out instruction to the back office computer system of the securities company automatically or manually when the current stock price reaches a loss cut stock price at which the compulsory reverse trading at the market is to be executed by the securities company, with excluding customer's feelings.

The interface can provide communication with the back office computer which is well known for general stock trading processes in securities companies. Thus, when the profit and loss calculation value reaches the threshold value, a closing out instruction may be send to the back office computer through the interface with the closing out indication being provided to the customer.

The interface can provide communication with the back office computer which is well known for general stock trading processes in securities companies. Thus, when the profit and loss calculation value reaches the threshold value, a closing out instruction is sent to the back office computer through the interface with the closing out indication being provided to the customer.

According to a fifth aspect of the present invention, the management system further comprises: first instruction means for instructing a back office computer at the securities company for executing actual transactions at the market about the execution of compulsory reverse trading at the market for the managed open position when the current stock price reaches a loss cut stock price at which the first compulsory reverse trading at the market is to be executed by the securities company.

According to this structure, when the current stock price reaches the stock price specified by the contract between the securities company and the customer, the first instruction means operates to compulsorily execute the closing out of the managed open position.

The first instruction means automatically can instruct the closing out without manual operation, so that the closing out can be made night and day.

According to a sixth aspect of the present invention, the management system further comprises second instruction means for instructing the back office computer about the compulsory reverse trading outside the market for the managed open position when the current stock price reaches a loss cut stock price at which the compulsory reverse trading outside the market is to be executed by the securities company or a party specified by the securities company.

Upon the closing out, if at the market there is no partner of trading for the stocks of the issues, the system repeats to order trading with renewing the limit order price that may be advantageous for the partner of trading. However, there may be still no partner of trading. In this case, when the current stock price reaches the second loss cut stock price at which the second reverse trading at the market is to be compulsorily executed by the securities company or a party specified by the securities company.

According to a seventh aspect of the present invention, the management system further comprises: relative transaction executing means coupled to the second instruction means for executing a relative transaction outside the market using the back office computer system in response to the second instruction means.

According to this structure, the relative transaction executing means can execute the relative transaction outside the market with the back office computer system in response to the output of the second instruction means.

According to an eighth aspect of the present invention, the management system further comprises notifying means for notifying a supervisory agent for the market about the execution of the relative transaction, when the relative transaction is executed.

The notifying means can notify the supervisory agent for the market about the execution of the relative transaction when the relative transaction is made to automatically perform the legal duty.

According to a ninth aspect of the present invention, the trading information includes customer identification information, and the system the management system further comprises: identification code generation means for generating an identification code corresponding to the customer; customer coding means for removing the customer identification information possible to identify the customer from the trading information shared by the securities company and the customer and adding the identification code to the trading information and searching and referring means for providing searching and referring the trading information to a third party including the customer with the identification code as a searching mark.

Thus, the information capable of identifying the customer can be removed from the trading information commonly shared between the securities company and the customer. In place of this, an identification code is added to the trading information for reference. Therefore, a third party including the customer can refer the trading information with the privacy of the customer being protected.

According to a tenth aspect of the present invention, the management system manages a plurality of open positions, and further comprises: given open position totalizing means for selecting given open positions from a plurality of the open positions in accordance with an intention of the customer and totalizing the profit and loss calculation values of the given open positions; and third instruction means for instructing the closing out of only the given open positions integrally in accordance with the totalized profit and loss calculation values of the given open positions.

According to this structure, the customer can select given open positions at the customer's account, and the profit and loss values can be totalized to integrally manage the given open positions for the closing out.

According to an eleventh aspect of the present invention, the management system instantaneously manages the open positions for each issue and defines a balance of long positions out of the open positions and a balance of short positions by short selling out of the open positions as a balance of received order for each issue from the customer to the securities company, the management system further comprising: for-each-issue rating storing means having a searchable function for storing ratings for each issue information which is optionally set by the securities company; for-each-issue reception-order-limit setting means for setting a reception order limit for each issue indicating a limit of received orders of each issue in accordance with at least one of the rating for each issue and optional setting by the securities company; and renewed limit display means for subtracting a balance of the received order from the reception order limit to generate a renewed limit for each issue and displaying the renewed limit to provide reference of the renewed limit within the securities company.

According to this structure, the issue of stocks, having a high possibility in that the stock price rapidly varies in such a direction that the loss expands, may be rated at a lower grade. On the other hand, the issue of stocks having a low possibility may be rated at a higher grade with optionally setting by the securities company. The set rated grades are stored in the rating for each issue storing means.

In accordance with the stored rating grades and other optional setting by the securities company, the reception order limit for each issue can be set. Basically, the higher rating grade is, the higher reception order limit is set.

The renewed reception order limit can be obtained by subtracting the balance of the reception orders from the reception order limit for each issue. The renewed reception order limits can be freely referred within the securities company.

The employee of the securities company can judge whether the current order exceeds the reception order limit simultaneously.

The reception of order for the stocks of issues having low rating grade can be restricted to decrease the risk of the closing out. This makes the execution of the loss cut service by buying by the securities company or the like easier.

According to a twelfth aspect of the present invention, the management system, further comprises differentiating means for differentiating a trading condition for each issue in accordance with a rating for each issue information stored in the for-each-issue rating storing means, the trading condition including at least one of a buying and selling charge, an interest, a loan stock charge, and expenses to be collected from a customer by the securities company.

According to this structure, the securities company can change the trading condition including at least one of a trading charge, an interest, loan stock charge, and expenses in accordance with the rating grade of the stocks of issue.

In particular, rating stocks of issues having a high possibility of closing out to a lower grade provides a risk hedge effect. That is, the securities company can set the trading condition including at least one of the interest, the loan stock charge, and expenses on the advantageous side of the securities company.

On the other hand, the stocks of issues having a low possibility of closing out by buying the stocks by the securities company are rated at a higher grade to provide customers trading conditions that are advantageous to the customers to promote the business.

According to a thirteenth aspect of the present invention, the management system further comprises notifying means for notifying the customer about an indication of the managed open position through the Internet.

According to this structure, customers can trade stocks with the loss cut through the Internet.

According to a fourteenth aspect of the present invention, there is provided a held stock management system comprising: display means for displaying trading information for compulsorily selling, at a loss cut specified stock price, each held stock of which management is requested by the customer, the held stock being purchased by cash trading and unsettled; transaction content storing means for storing content of a transaction; and stock price information collecting means for collecting renewed stock price information, wherein the display means displays, at an indication frame capable of integral indication in a unit as long as the held stocks have the same issue, the same transaction day, and the same price, at least one of first indication indicating a first loss cut specifying stock price for instructing compulsorily selling within a market when the renewed stock price exceeds a first decrease rate to act an automatic loss cut for the customer for each stock and a second indication indicating a second loss cut specifying stock price for instructing compulsorily selling outside the market when the renewed stock price exceeds a second decrease rate to act the automatic loss cut for the customer for each stock, the system further comprising a loss cut function for effecting the automatic loss cut at the first and second loss cut specified stock prices for each stock in an account of the customer when the renewed stock price exceeds a first decrease rate and when the renewed stock price exceeds a second decrease rate.

According to a fifteenth aspect of the present invention, there is provided a management system comprising: display means for displaying an open position subjected to the compulsory closing out for each open position, ordered by a customer, out of trading information shared with a customer with which a securities company executes margin trading including loaned money and stocks and buying and selling stocks using a credit accommodation; consignment guarantee money storing means for storing an amount of consignment guarantee money deposited in the securities company by the customer; transaction content storing means for storing a transaction content including an agreed-up price of an open position regarding margin trading depending on money or stock loaned from the securities company by the customer; stock information collecting means for collecting a renewed stock price; unrealized profit and loss calculation means for calculating an unrealized profit and loss in accordance with at least one of an unsettled interest, an unsettled loan stock charge, and an unsettled expenses and the trading information including the renewed stock price; consignment guarantee money maintenance rate calculation means for calculating a consignment guarantee money maintenance rate at a unit of management of open positions of each issue traded on the same day at the same price by substituting values of the renewed consignment guarantee money, the agreed-up price of the open position, and the unrealized profit and loss for an equation corresponding to the transaction content; threshold value storing means for storing a threshold value specified regarding the consignment guarantee money maintenance rate for each open position; managed open position extraction means for extracting a managed open position to be compulsorily closed out from the open positions in an account of the customer when the consignment guarantee maintenance rate reaches the threshold value of consignment guarantee money maintenance rate; and managed open position display means for displaying the managed open position to be subjected to the closing out extracted by the managed open position extraction means with an distinctive indication.

According to this structure, for example, whenever the date, stock price, and other conditions are renewed, the profit and loss calculation value is renewed. This is monitored and compared with a threshold value to execute the closing out. The customer and the securities company agrees in the threshold value to provide the automatic closing out for each open position before the execution of trading to exclude customer's intention or feelings. Thus, the customer can be provided with this service only inputting agreement key operation through the Internet.

The system stores the agreed-upon price, the interest rate, and at least one of the loan stock charge and expenses, renews the profit and loss in accordance with at least one of the unsettled interest and the unsettled loan stock charge or the like corresponding to the consignment guarantee money, the renewed stock price, and the number of days from the trading, and calculates the consignment guarantee money maintenance rate with the equation corresponding to the type of the trading.

The system stores the agreed-upon price, the interest rate, at least one of the loan stock charge and expenses, and renews the profit and loss in accordance with at least one of the unsettled interest and unsettled loan stock charge or the like corresponding to the consignment guarantee money. The system further stores the number of days from the trading, and thus, the system can calculate the consignment guarantee money maintenance rate with the equation corresponding to the type of the trading.

Thus, when the consignment guarantee money maintenance rate reaches the threshold value, the stocks are compulsorily closed out by the securities company.

Thus, a lot of open positions are efficiently monitored and if there are open positions of which profits are sequentially closed out.

The calculation of the consignment guarantee money maintenance rate is difficult to be calculated by a customer, so that the automatic calculation is useful and provides sure result with excluding the customer's intention.

When the consignment guarantee money maintenance rate reaches the set threshold value, the securities company compulsorily executes the closing out in accordance with the contract.

The managed open position is immediately displayed on list with a distinctive indication. The indication may be provided a numerical indication, a color indication, or digital data or the like.

A sixteenth aspect according to the present invention uniformly suppresses the loss for each open position or each stock in the customer's account within a predetermined limit. Thus, the customer can trade stocks, wherein the risk for each stock is surely limited.

A seventeenth aspect according to the present invention compulsorily executes the closing out for a minimum unit including open positions of the same issue traded at the same day at the same price, when the consignment guarantee money maintenance rate reaches the threshold value.

Thus, it is prevented to hold stocks that cannot be sold for a long time. Thus, each stock or each open position can be managed with assumption of the closing out, so that, for example, it is prevented that the unrealized profit and loss of the stock, of which price decreased, influences other good open positions with good investment performances and that the collateral for these stocks are unloaded.

Either the profit and loss can be calculated at the minimum unit of managing the open position having the same trade day, the same price, and the same issue, or the profit and loss of a plurality of issues of stocks can be integrally calculated. Thus, the customer can knows the profit and loss of each given issue of stocks or a group of stocks. As a result, the customer can hold the stocks as the whole or a given unit, so that trading is adaptively executed in accordance with the circumstance.

Further, the customer can be provided with the distinctive indication of the managed open position of which price reaches the specified threshold value in real time. Thus, the managed open positions having a low investment performance can be compulsorily closed out at an earlier timing without the customer's feeling or current intention, and the customer is informed of the execution of the closing out.

According to this structure; the customer can be informed of the execution of the closing out at an earlier timing, wherein the customer's intention is excluded in the decision of the closing out.

According an eighteenth aspect of the present invention, the system can shift the risk at the customer to the securities company. The securities company can manage the risk hedge of the customer's side.

The risk hedge does not load largely on the securities company because the securities company is skilled in the business and this system may increase the number of customers due to the risk hedge.

According a nineteenth aspect of the present invention, this system can shift parts of loss risks in stock investments of individual customers to the securities company which combines them into a large scale of money, open positions, or stocks which are invested for hedging the loss risks. This load of risk is not so large because the securities company is skilled in investment.

This system decreases the load on the customer regarding the loss cut, so that the customer can concentrate on buying for the next trade.

This system can decrease the load on the customer regarding the first closing out, which may increase demands for the trade by the general individual investor.

The renewed for-each-issue renewed limit is informed to the employee in the securities company, so that the employee can prevent the risk to exceed the safe limit. Further, the rating each issues can adaptively cost the customer in accordance with the risk of the issue.

### BRIEF DESCRIPTION OF THE DRAWINGS

The object and features of the present invention will become more readily apparent from the following detailed description taken in conjunction with the accompanying drawings in which:

FIG. 1 is an illustration of a system for managing open positions and stocks according to the present invention;

FIG. 2 is an illustration of a principle operation according to the present invention;

FIG. 3 is a graphical drawing illustrating an example operation according to the present invention;

FIG. 4 is an outline block diagram of the system, shown in FIG. 1, according to the present invention;

FIG. 5 is a block diagram of a business computer, shown in FIG. 4, used in the system according to the present invention;

FIG. 6 is an illustration describing a logical structure of a stock trading file according to the present invention;

FIG. 7 depicts a flow chart illustrating a basic management processing according to the present invention;

FIG. 8 depicts a flow chart describing an access procedure to this system from a customer terminal according to the present invention;

FIG. 9 is an illustration of a format of a balance sheet for managing a long position according to the present invention;

FIG. 10 is an illustration of an example of an actual balance sheet according to the present invention;

FIG. 11 depicts a flow chart describing a detailed management process according to the present invention;

FIG. 12 is an illustration describing functions of the system adapter according to the present invention;

FIG. 13 is an illustration describing a collateral specification for managing long positions according to the present invention;

FIG. 14 is an illustration of an example of a customer deposit passbook according to the present invention;

FIG. 15 is an illustration of a trading report for managing a long position according to the present invention;

FIG. 16 is an illustration of the system in which the system adapter is installed at an external supporting agent according to the present invention;

FIG. 17 is an illustration of a management table (A) of open positions according to the present invention;

FIG. 18 is a management table (B) of open positions according to the present invention;

FIG. 19 is a management table (A) of held stocks;

FIG. 20 is a held stock management table (B) of cash trading according to the present invention;

FIG. 21 is an illustration describing a relative trading outside the market using a back office computer system according to the present invention;

FIG. 22 is an illustration describing for-each-issue rating information according to the present invention;

FIG. 23 is an illustration of a display for short open positions with rating information according to the present invention; and

FIG. 24 is an illustration of a display for long positions and short positions by short selling with rating information according to the present invention.

The same or corresponding elements or parts are designated with like references throughout the drawings.

### DETAILED DESCRIPTION OF THE INVENTION

Hereinbelow will be described an embodiment of the present invention with reference to the accompanied drawings.

Throughout the specification, “this system” means each or either of an open position management system with indication for loss cut at a specified rate, a held stock management system with indication for a loss cut at a specified rate, or an open position management system with indication for a loss cut at a specified consignment guarantee money maintenance rate (guarantee money maintenance rate).

However, if there is an indication word “guarantee money maintenance rate” in any drawing, the drawing describes the open position management system with indication for a loss cut at a specified guarantee money maintenance rate.

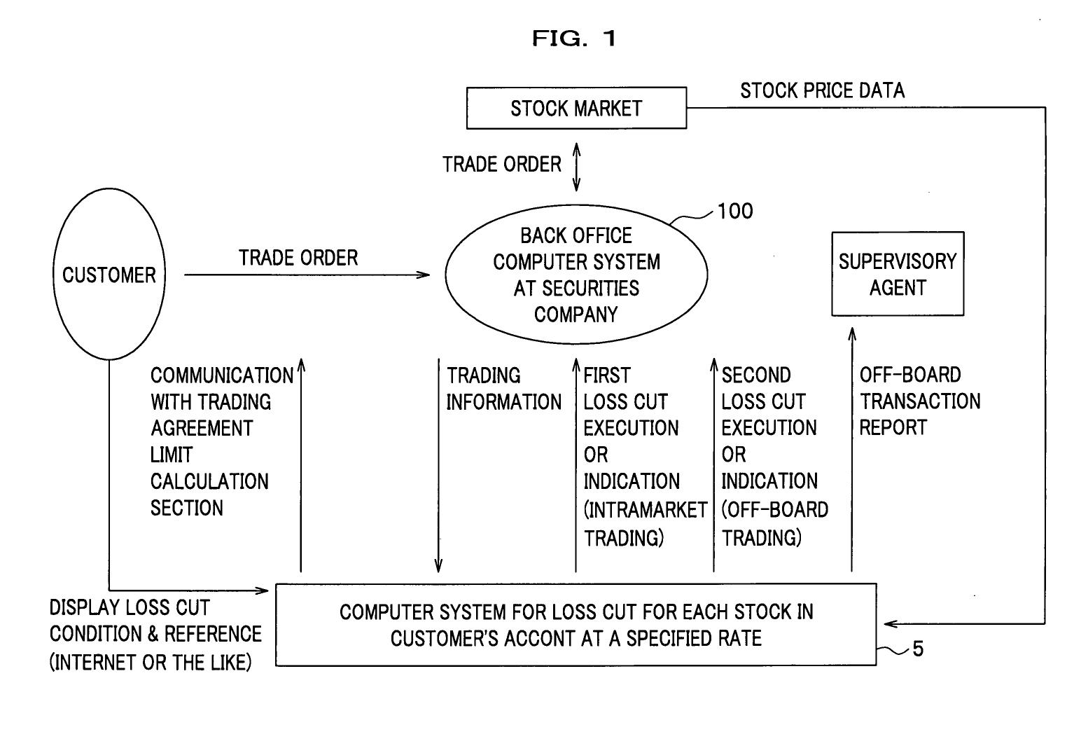

This system 5 is a supporting system provided for the back office computer system of a securities company shown in the middle of the drawing of FIG. 1. Thus, this system is coupled to the back office computer 100 to operate as a supporting system for supporting the back office computer internally or externally.

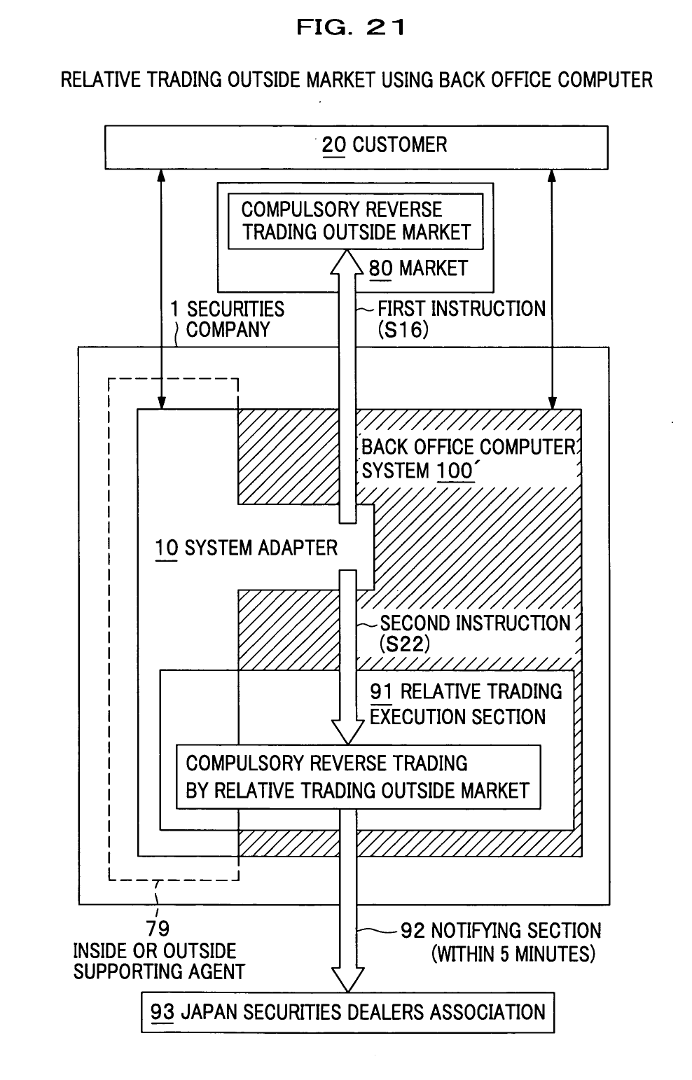

The example shown in FIG. 1 is provided as the supporting system outside the back office computer system 100. However, it is also possible to provide this supporting system inside the back office computer system 100 (refer to FIG. 21).

As shown in FIG. 1, the back office computer system 100 has all of functions including managing and maintenance by forwarding a trading order from a customer to a stock market in accordance with a request for a trading order and booking the result at an account of stocks for each customer.

This system 5 forms a computer system for providing agent services of the loss cut at a specified rate for each stock in the customer's account through cooperation with the back office computer system 100.

To provide the loss cut agent services, this system 5, cooperative with the back office computer system 100, executes communication with a trading agreement limit calculation section in the back office computer system 100, interchanges reception and transmission of trading information, and sends the first loss cut execution instruction, i.e., its order, by intramarket trading, and the second loss cut execution instruction i.e., its order, by an off-board transaction to the back office computer 5 in real time base. Further, this system 5 also reports the off-board transactions to the specified government about the execution or transmission of the second loss cut outside the market in response to the execution or instruction of the second loss cut.

This system 5 is capable of communication with customers to keep close relationships with customers to indicate and provide reference or a display of the loss cut condition through the Internet or the like. If a customer contracts a “specified rate” for loss cut with the securities company, this system automatically executes the loss cut at this setting value for all transactions after this contract. Further this system can directly or indirectly collect stock price data necessary for the loss cut at the “specified rate”.

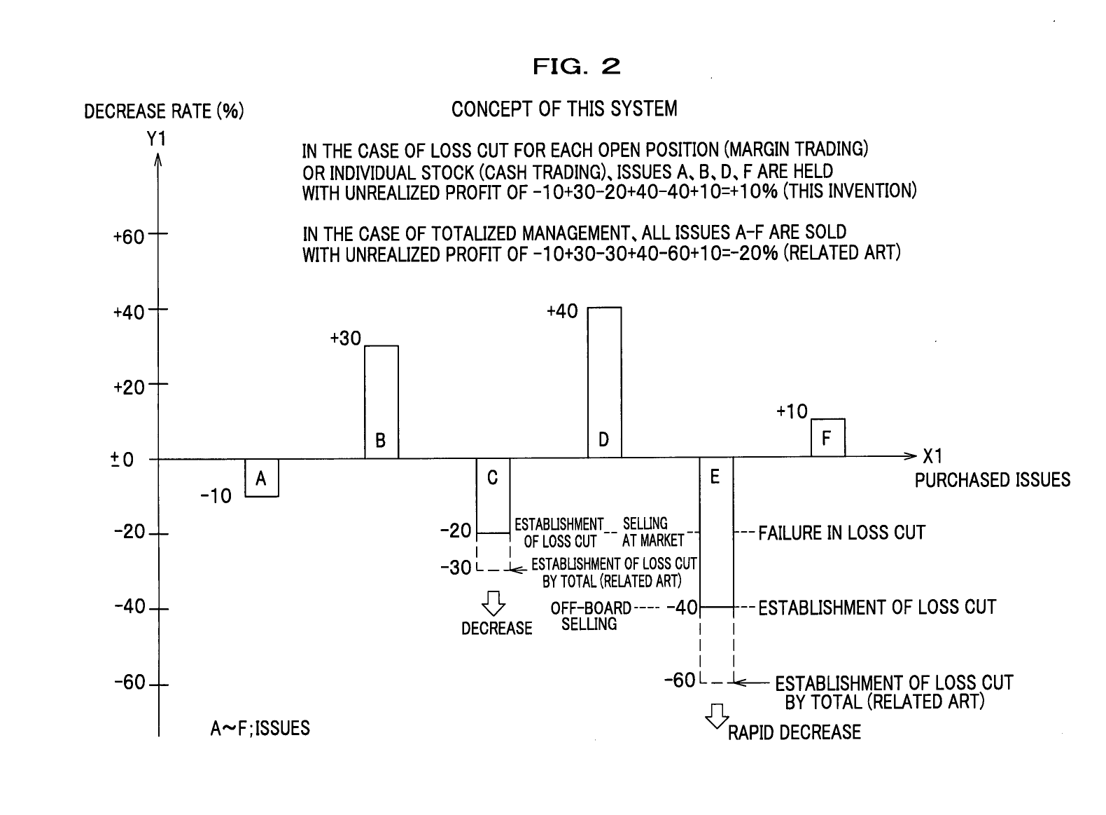

FIG. 2 is an illustration describing the conceptive operation of this system. The axis of abscissa X1 represents purchased stocks for each issue and the axis of ordinate Y1 represents variations of stock price in the forms of pillars with that the buying stock price is assumed to be 0%.

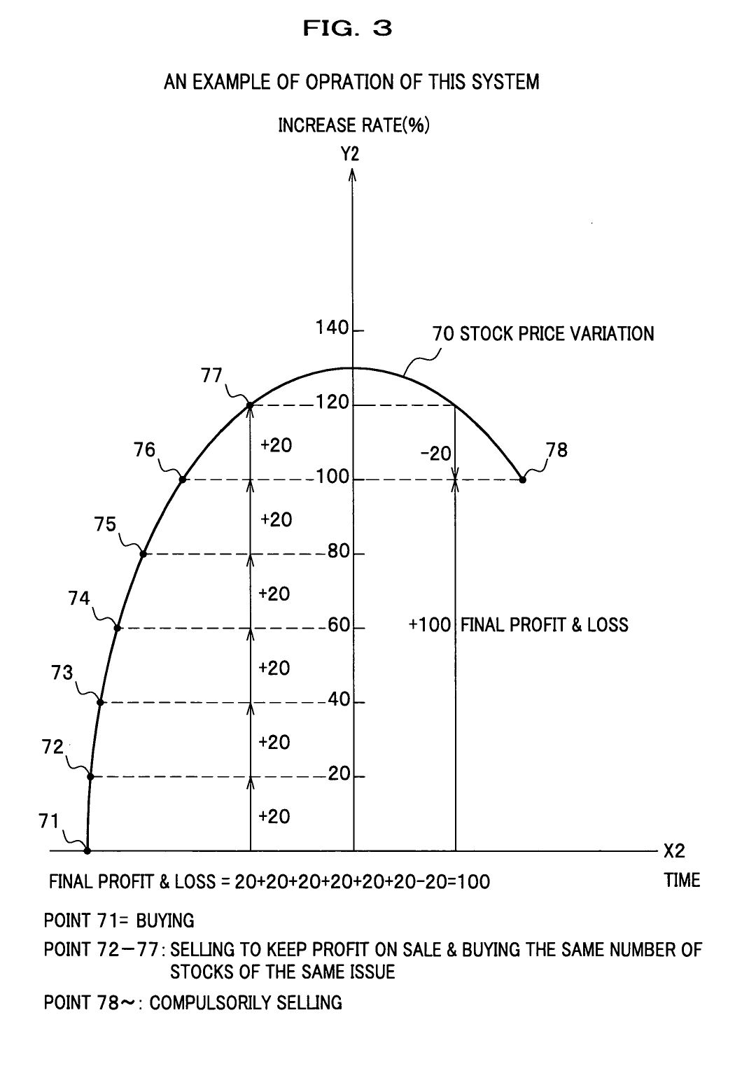

Further in this system shown in FIGS. 2 and 3, it is assumed that cash trading is done and a contract is established between a customer and a securities company 1 to compulsorily sell the stocks at the market by the securities company 1 when the stock price decreases from the buying price by 20% and to compulsorily sell the stocks outside the market if the stock cannot be sold and the stock price decreases by 40% of the buying price, i.e., the stocks are purchased by the securities company 1.

FIG. 2 represents the case that issues A, B, C, D, E, and F are successively bought at different timings and the variation of the prices and the profits and losses at time after the recent purchase.

The issue A decreases 10% in price from the buying price. The issue B increases 30% in price from its buying price. The issue C decreases 20% in prices from its buying price (represented by the solid line pillar). The issue D increases 40% in price from its buying price. The issue E decreases 40% in price from its buying price (represented by the solid line pillar). The issue F increases 10% in price from its buying price.

Here, it is also possible to consider all issues A to F as different open positions of the same issue at different buying prices. Here, to briefly describe the example, it is assumed that the issues A to F are different issues of stocks and a thousand of stocks were bought for each issue at a million yen. Then, the value of the percent of the stock price variation is readable as the profit and loss in the unit of ten thousands yen. Thus, the total of the unrealized profits and losses of all the issues A to F shown in FIG. 2 can be obtained as −10+30-20+40-40+10=10 (1=ten thousands yen).

Here, when the total of the unrealized profits and losses is a hundred thousand yen, if the customer can execute the loss cut only for the issues C and E of which prices decrease, the customer can search another way for trading. However, it is general that the customer falls in the optimistic decision because the customer considers that the loss cut for the issues C and E can be cancelled since the total is in the profit side.

When the customer is aware of the erroneous decision, it is too late to recover the error judgment, so that there is no recovering way. As a result, the issues C and E having the decreased prices become “frozen stock”. If they are sold, the unrealized profits and losses are realized.

Here, consider that the operation shown in FIG. 2 is managed in accordance with the totalized profit and loss by the conventional margin trading. If the loss cut threshold line according to the totalized profits and losses is −20%, the total of the profit and loss is +a hundred thousands yen, so that the securities company 1 does not execute the loss cut. However, it is further expected that the issue C will further decrease and the issue D will rapidly decrease. Thus, as shown by chain lines of the issues C and D, if the stock prices further decrease by 30%, the total profit and loss of all issues A to F becomes minus two hundreds thousand yen, so that all issues of stocks A to F are sold together. This is totalized management operation and thus, though there is a decreased price issue among the issues in the customer's account, the loss cut cannot be executed until the totalized profit and loss reaches the threshold level.

More specifically, though the customer desires to execute the loss cut at an earlier timing, the loss cut is not executed until the loss in the issue C becomes −30% due to the further decrease of 10% and as well as the loss in the issues E becomes −60% due to further decrease of 20%. In other words, the loss cut function does not operate until the totalized loss reaches 20%.

The loss in the securities company can be restricted at the minimum level if there is no delay of the timing of selling all issues of stocks. However, the stocks indicating increase in stock price such as B, D and F issues are also compulsorily sold.

Here, when the totalized profit and loss is in the plus side, i.e. plus a hundred thousand yen, it is desirable to decide the loss cut for each stock or open position on the securities company side, which was considered to be difficult for the customer to decide the loss cut due to weakness in his mind.

This may suppress the loss in the securities company 1 also because if there is a delay in integrally selling timing, the loss will expand, so that the collection for the bond may become impossible. Thus, it is desirable to decide the execution of loss cut for each stock or each open position with a predetermined threshold value regarding the profit and loss of the stock or the open position.

Thus, the loss cut for each open position in the customer account at a specified rate excluding customer's intention provides profits both to the customer and the securities company. In this case the blue chip issuers B, D, and F are held, but only the subordinated issue stocks C and E are subjected to the loss cut, wherein the profit is remained.

FIG. 3 is a graphical drawing illustrating the variation in the stock price, wherein the axis of abscissa represents time and the axis of the ordinate Y2 represents the stock price variation rate with reference to the buying price. Thus, the stock price variation 70 represents the stock prices thereon at trading executed points 71 to 78 to represent the history and the final profit and loss.

Also here, to briefly describe the example, it is assumed that a thousand of stocks of an issue are bought for a million yens at a thousand yen per stock at a point 71. Then, the percent representation also indicates the profit and loss in the unit of ten thousands yen.

The stocks bought at the point 71 are subjected to profit-taking selling at a point 72 at which its stock price increases by 20% and as well as the same number of stocks of the same issue are bought at the same price. This synchronous selling and buying the same number of the same issue stocks is executed at each of points 72 to 77. At a point 78, the stock price decreases by 20% from that at the point 77, so that all stocks are compulsorily sold at the point 78 to finish the sequential trades. Finally, a million yen of profit can be safely provided.

In the sequential trades shown in FIG. 3, when the current stock price decreases by 20% from the previous stock price, the stocks are compulsorily sold as an automatic selling function. Thus, during an upward trend, the stored stock price is set the new high price at each trading. Thus, when the stock price decreases by 20% from the recent buying price, the stocks are compulsorily sold. Consequently, the stocks are bought at a low cost and sold at a higher price.

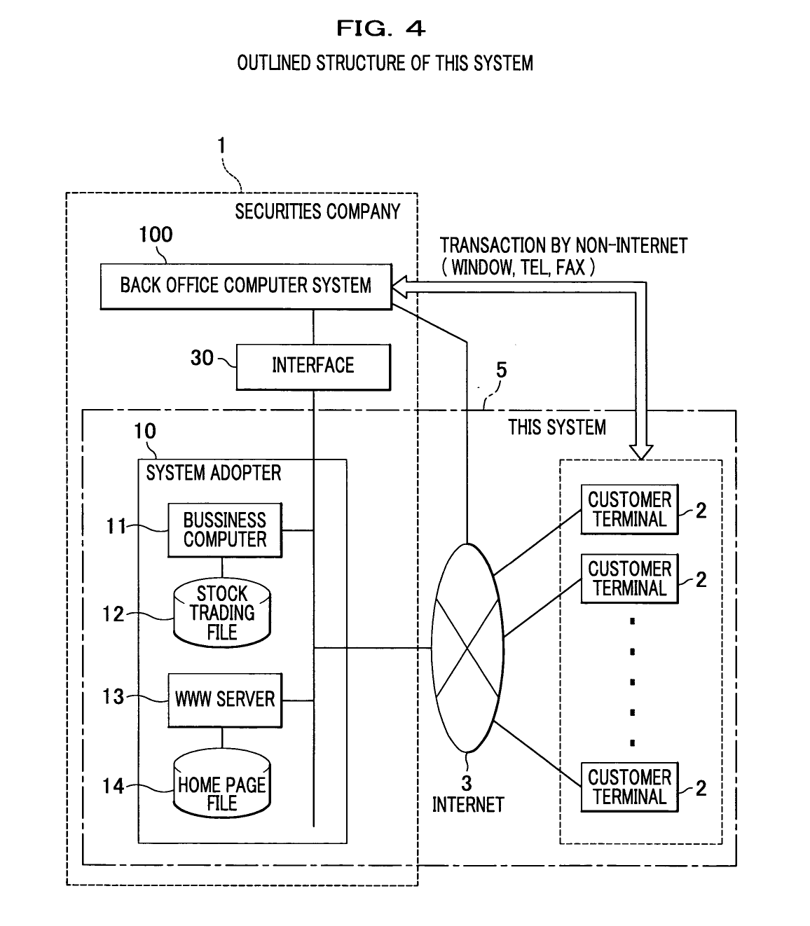

Here, consider that the “loss cut timing” for the stocks is determined only by a person without using this system 5. In the case of the upward trend as shown in FIG. 4, it is difficult to judge the turning point from an increase trend to a decrease trend, so that the person frequently sells at any intermediate point between the points 72 and 77. Thus, the person cannot obtain the possible profit that would be provided at the point 77 near the maximum price. Therefore, though the stocks are in an upward trend, a half of the profits are abandoned.

On the other hand, the use of this system 5, it is possible to buy the stocks at a low cost and sell at a higher price if the stocks are in an upward trend.

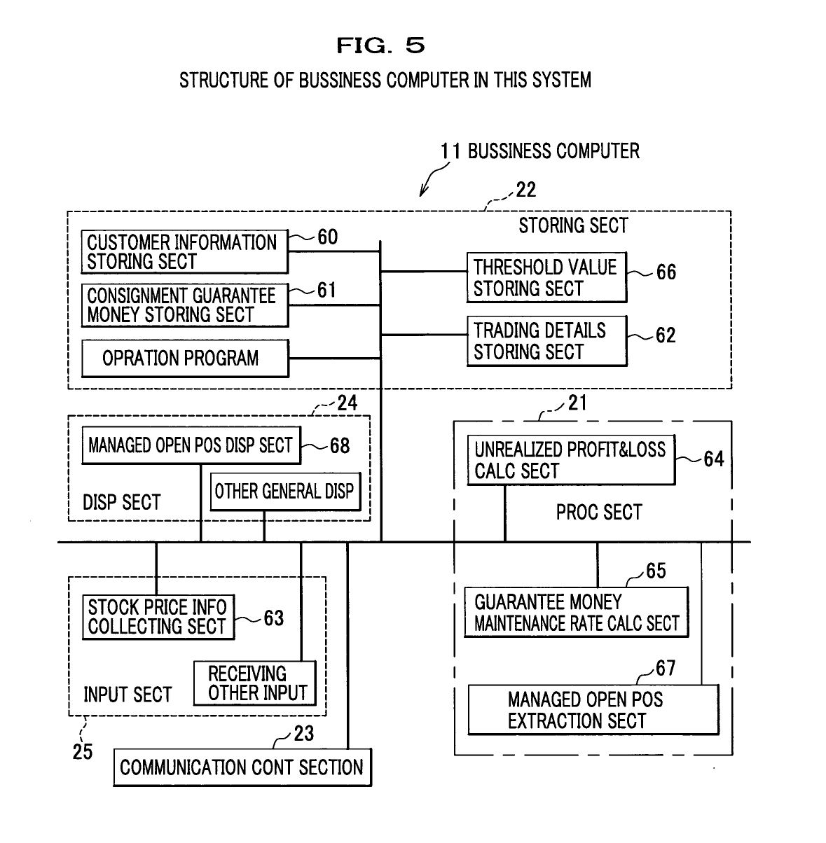

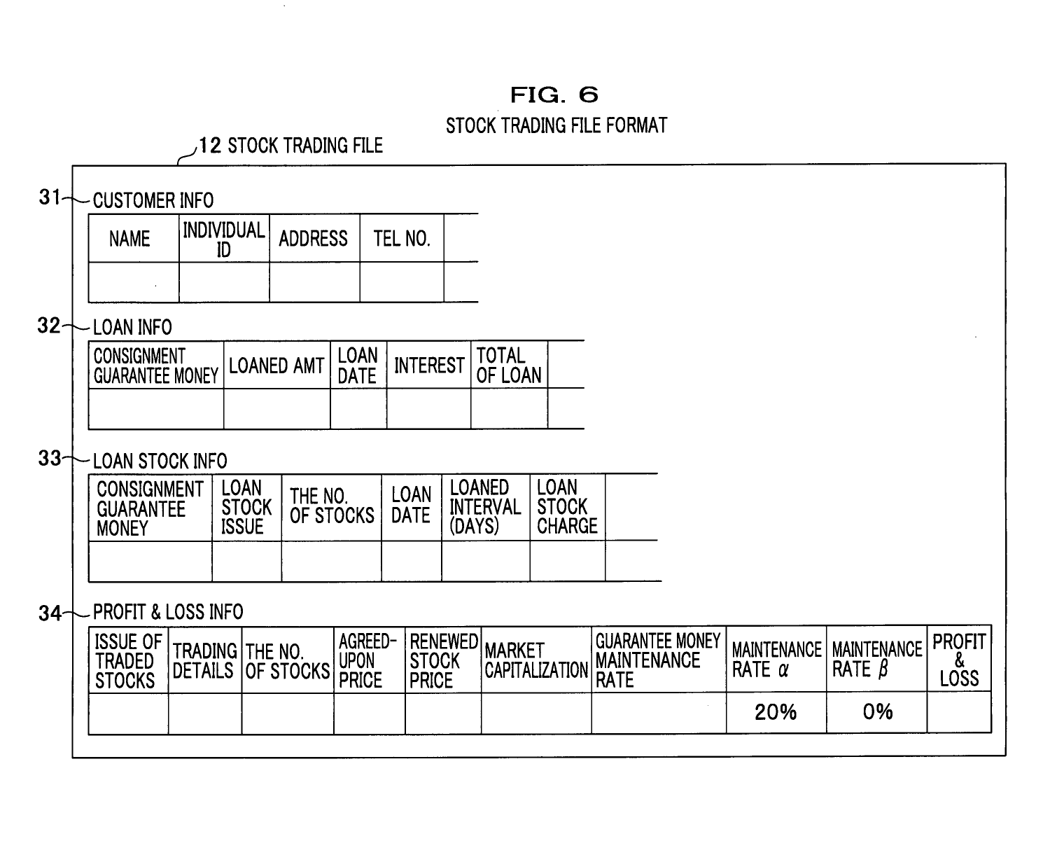

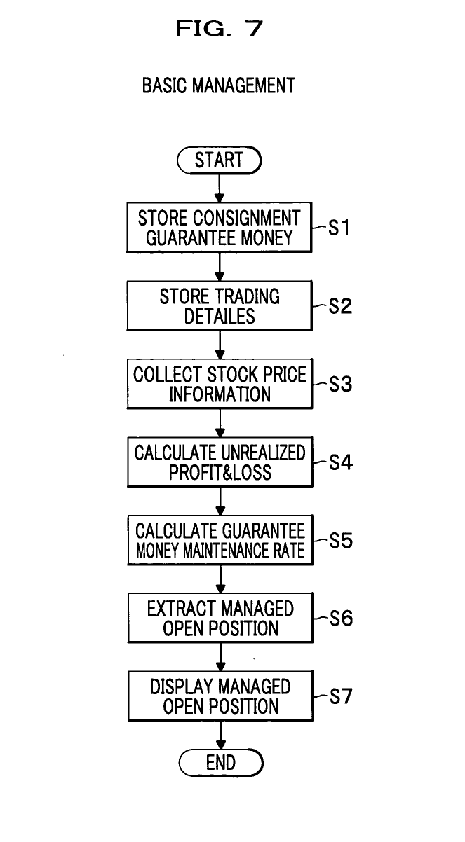

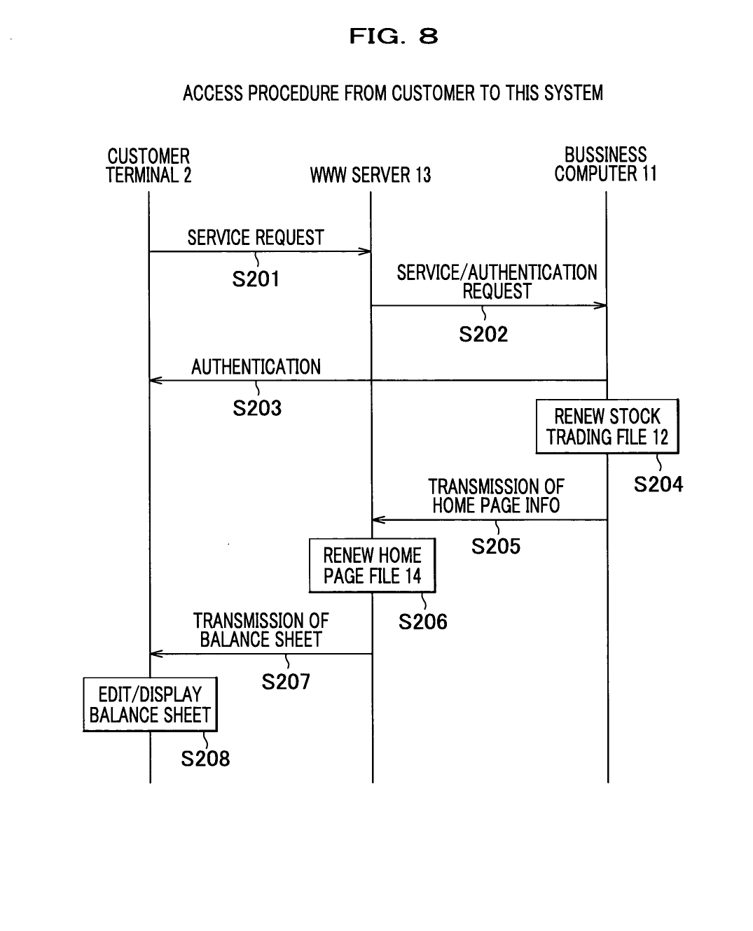

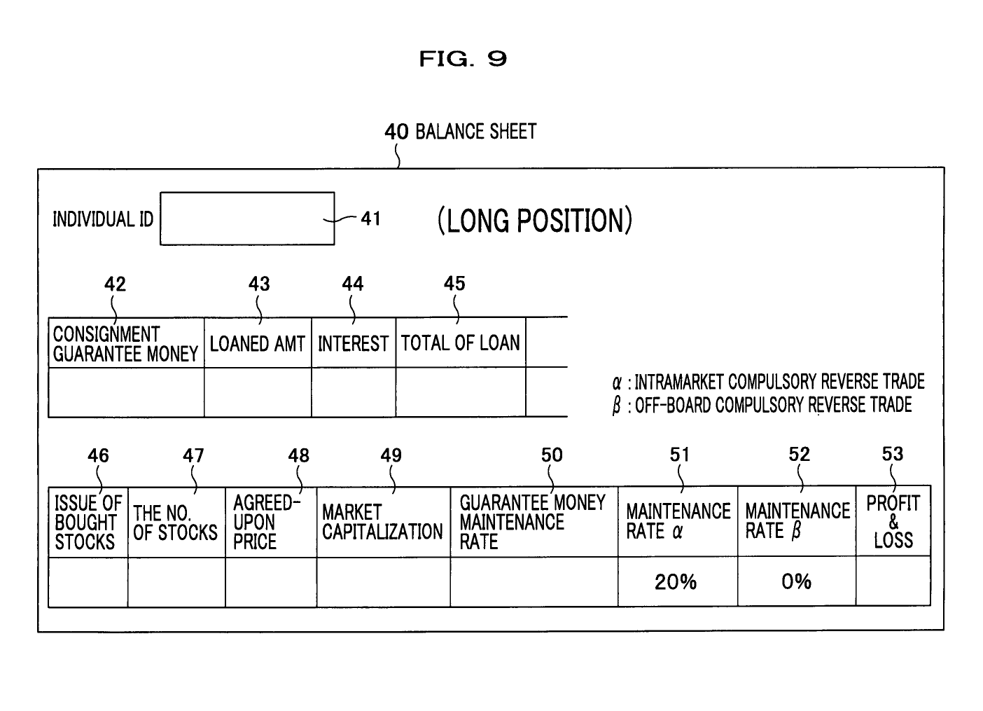

FIG. 4 is a block diagram of this system 5 according to an embodiment of the present invention, and FIG. 5 is a block diagram of a business computer 11 shown in FIG. 4. FIG. 6 is an illustration showing a format of a stock trading file 12. FIG. 7 depicts a flow chart describing a basic management method according to the embodiment of the present invention. FIG. 8 depicts a flow chart illustrating an access procedure from a customer to this system 5. FIG. 9 is an illustration of a balance sheet for managing long positions. Hereinafter, the management of long positions will be mainly described and the operation can be also applied to buying back of short-sold open positions as modification.

The outline structure of this system 5 will be described with reference to FIG. 4. As shown in FIG. 4, this system 5 comprises the securities company 1, a customer terminal 2, and the Internet 3 providing coupling among them. Here, the customer terminals 2 and the Internet 3 may be replaced with other substitution units and communication medium, respectively.

In response to a request from a customer, the securities company 1 requests the securities exchange to commit the trade as its known general business. Further, the securities company 1 is also an agency for financing or loaning money for trading within a limit of which value is derived by multiplying the consignment guarantee money by a predetermined value.

As defined in the rule 41 of Brokerage Agreement standards of the Tokyo stock exchange, the field of business legally allowed for the securities company 1 covers: the business including loaning the sold negotiable securities based on the collateral of the cost of sold stocks by margin trading and the consignment guarantee money; and the business including loaning money of which amount corresponds to the total of the bought stocks at the agreed-upon price based on the collateral of the cost of the sold stock and the consignment guarantee money.

Further the Tokyo stock exchange defines the cost of the excessive loan stocks regarding loaning negotiable securities (hereinafter referred to as loan stock) defined by the second item of the rule. However, since the cost of loan stocks may develop a backwardation rate in which the relation of payment of money may be inverted, all businesses shall conform to the rules.

For example, the securities company 1 loans a customer 100% of stock buying money. The securities company 1 keeps the purchased stocks and the received consignment guarantee money as a collateral at the same time as loaning. Further, the securities company 1 opens a home page capable of reference by the public through the Internet 3 to provide the loan information and the profit and loss information to each customer.

The securities company 1 uses the back office computer 100 for processing the most part of the general business, but its detailed description will be omitted because this system is well known in the art. Further, this system 5 mainly includes a system adapter 10 for directly or indirectly transmitting and receiving information to and from the back office computer 100 through an interface 30 with assumption that the back office computer 100 can perfectly process the general business.

Further, this system 5 may include the back office computer 100 and the interface 30.

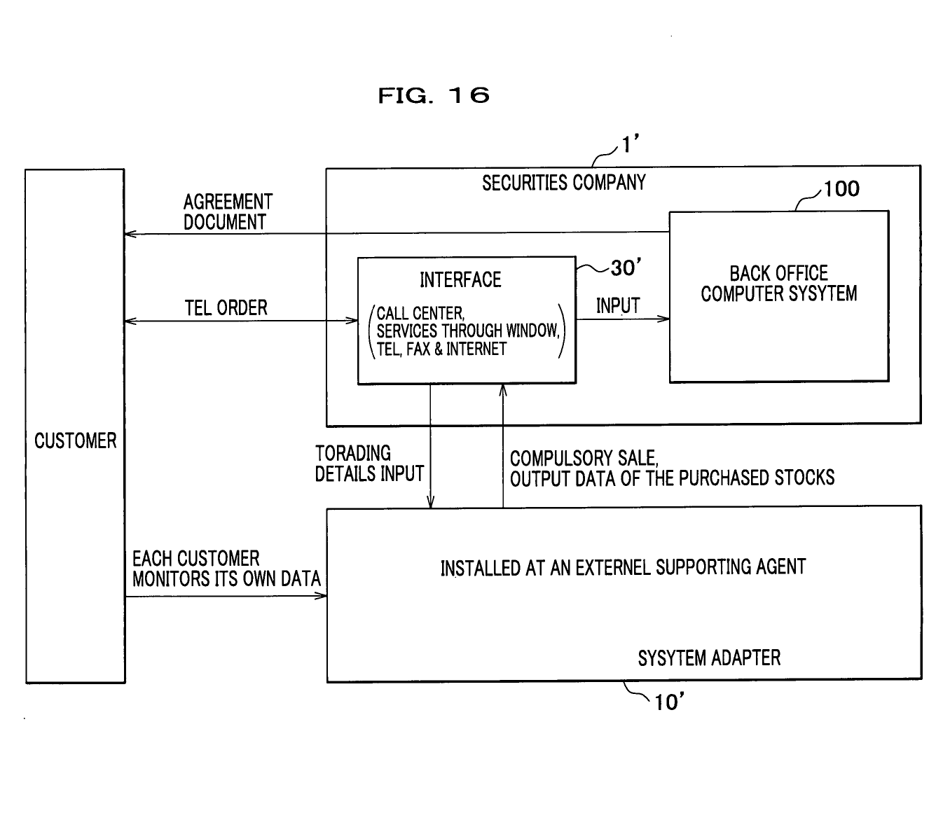

Still further, the system adapter 10 may be built in or added to the back office computer 100 to provide an integrated operation. However, the adapter 10 may be installed apart from the back office computer 100 and has a similar structure to the back office computer 100 at a smaller scale to provide electronic trading with the customer terminals 2 independently. In this case, it is necessary to define the system adapter 10 as an outside assistant agent (refer to FIG. 16 mentioned later) for the securities company 1 and thus, trades deviating from the definition may be considered as an illegality.

The system adapter 10 includes the business computer 11 and a WWW server 13. The business computer 11 has a stock trading file 12, and the WWW server 13 has a home page file 14. The customer terminals 2 are provided for customers, for example, to buy stocks with loan from the securities company 1 for buying stocks.

Further, the system adapter 10 is not limited to the long position, and thus, can act as a teller for arranging fixing up loan stocks upon buying back by a short sale in an unmanned manner. However, the description about the short sale function is omitted throughout the specification, but the closing out by a profit taking sale or loss cutting mainly for long positions is exemplarily described.

The customer accesses the WWW server 13 through the Internet 3 by operating the customer terminal (refer to FIG. 8) to acquire the loan information and profit and loss information regarding the traded issues of stocks.

The business computer 11 at the securities company will be described with reference to FIG. 5. The business computer 11 generates and renews the stock trading files 12 and, as shown in FIG. 5, includes a processing section 21, a storing section 22, a communication control section 23, a display section 24, and an input section 25.

The processing section 21 executes various types of calculations. The storing section 22 stores various types of information. The communication control section 23 executes the process of connection with the Internet 3. The display section 24 executes displaying on a screen of a monitor (not shown) and printing with a printer (not shown) when the specified maintenance rate is equal to or higher than a specified threshold value. The input section 25 is provided for inputting various types of information.

The rule regarding the process for “the case that the maintenance fee is equal to or greater than the specified threshold value” is established by agreement with the rule prepared by the securities company 1. The rule cannot be withdrawn until the completion of the trading.

The business computer 11 generates and renews the stock trading file 12 (refer to FIG. 6 mentioned later) in the storing section 22 by calculating and processing the customer's information, the loan information, and the stock price information acquired from an external information providing agent (not shown) through the communication control section 23 and the Internet 3.

The storing section 22 includes the internal storing device (memory) and an external storing device (hard disc drive or the like) of the business computer 11 and functions as a customer information storing section 60, a consignment guarantee money storing section 61, a threshold value storing section 66, a trading details storing section 62, and a storing section for storing the operation programs.

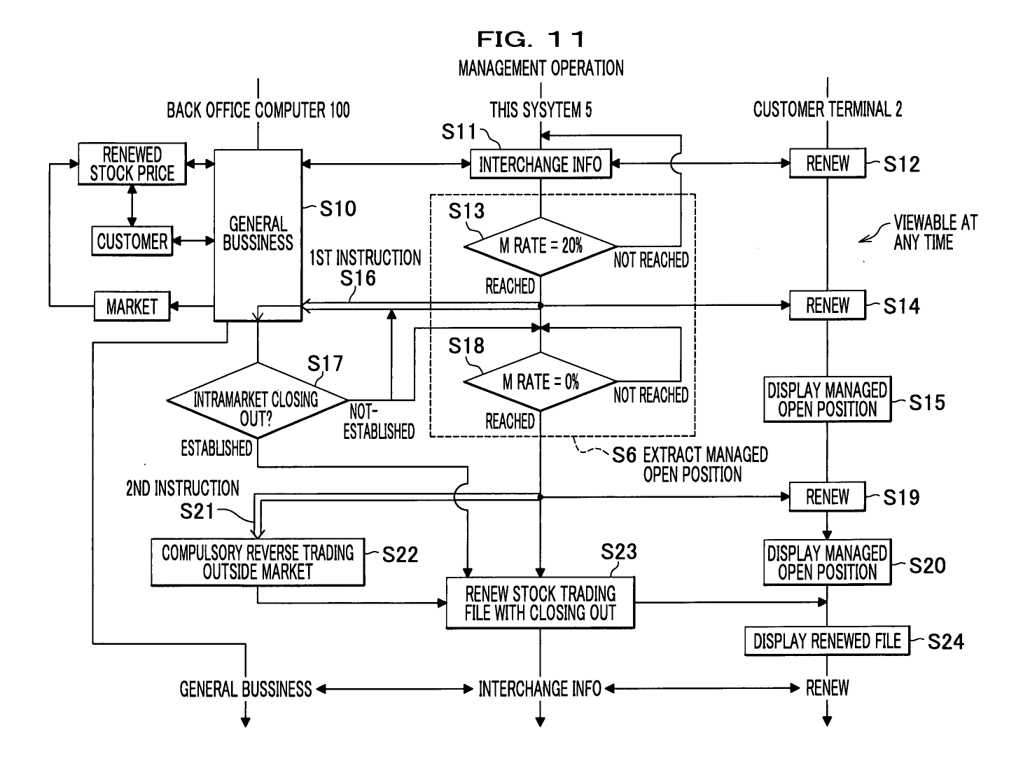

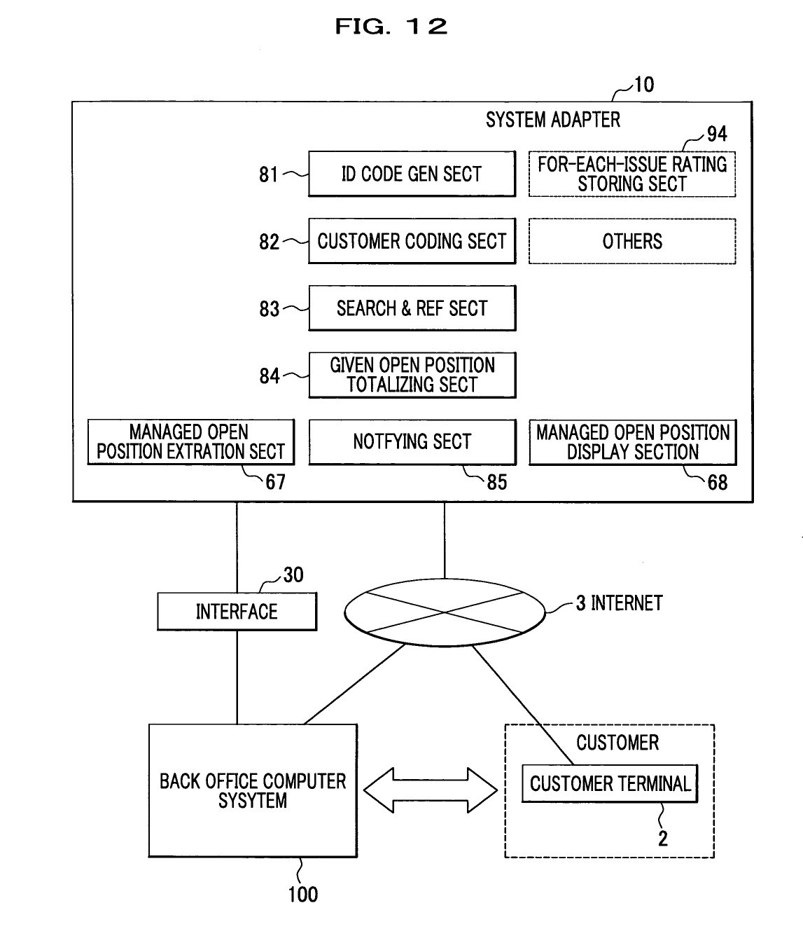

The input section 25 includes a stock price information collecting section 63 which collects renewed stock price information or the like (hereinafter referred to as renewed stock price) and makes also the processing section 21 share the renewed stock price to allow an unrealized profit and loss calculation section 64 comprising a calculation program, a maintenance rate calculation section 65, and the managed open position extraction means 67 in the processing section 21 to cooperate. The managed open position extraction section 67 sends an indication to the processing section 21. The managed open position extraction section 67 sends a display instruction to a management open position display section 68 to execute a displaying operation and a closing out process (refer to FIGS. 11 and 12 mentioned later).

Further, the managed open position display section 68 displays the managed open position and the specified maintenance rate both at the securities company 1 and the customer terminal 2. When the managed open position display section 68 is requested to display the managed open position to be immediately dealt with on a readable list, the management open position is distinctively displayed by indication that the maintenance rate reaches a threshold value α or β. The distinction may be made in any distinctive manner such as a numeral indication, a colored indication in specifications, an extracted separate list, and electronic data that can be simply transmitted and read.

The processing section 21 includes an unrealized profit and loss calculation section 64 for calculating the result of investment in stock trading and displaying it in a negative or positive value.

For example, if stocks bought at a low price using loan on the basis of the consignment guarantee money can be sold afterward at a higher price as profit-taking selling, the profit and loss is calculated by subtracting the interest and the commission from the gross profit to inform both the securities company 1 and the customer of it.

Regarding the calculation equation, the trading details storing section 62 selects and uses one of equations in accordance with the type of the trading such as “short sale open position” and “long position”. The values applied to the equation are derived from an amount of the consignment guarantee money from the consignment guarantee money storing means 61 in the storing section 22 in addition to the renewed stock prices and interests. Further, the threshold values a and p stored by the threshold storing section 66 are values determined by the contract with the customer. For example, when the guarantee money maintenance rate reaches α=20% (or a higher value in accordance with the contract), the closing out is compulsorily executed in the market, and when the guarantee money maintenance rate reaches α=0% (a fixed value), the closing out is compulsorily executed outside market. Further, the indication of the execution of the closing out is displayed (refer to FIG. 11 mentioned later).

Referring now to FIG. 6, a format of the stock trading file 12 will be described. The stock trading file 12, as shown in FIG. 6, includes customer information 31, loan information 32 for the customer, loan stock information 33 regarding stocks from which the customer rented by mediation by the securities company 1 for a short sale, and profit and loss information 34 of the traded issue of stocks.

The customer information 31 includes the name of a customer, the individual ID, the address, and information influencing the rating of credit, which are stored and secretly managed in the customer information storing section 60 (FIG. 5). The loan information 32 includes information of the consignment guarantee money, the loan amount, the loan date, the interest, the total of loan, and the like. The loan stock information 33 includes the consignment guarantee money, the loan issue, the number of stocks, the loan date, the number of days for which stocks are loaned, the loan stock charge, and the like. The profit and loss information 34 includes information of the trading issue, the trading details (content), the number of stocks, the agreed-upon price, the renewed stock price, the market capitalization, a guarantee money maintenance rate (consignment guarantee money maintenance rate), the maintenance rate, the specified threshold values of the guarantee money maintenance rate, the profit and loss, and the like.

Here, “guarantee money maintenance rate” is the same as “maintenance rate” and they are properly used in a separate manner in accordance with occasions. Similarly, threshold values α and β of the specified guarantee money maintenance rate are simply called “maintenance rates α and β”.

Further, according to the securities market (Tokyo) trustee contract rule No. 48 “maintenance of trusted guarantee money for margin trading”, the securities company 1 shall make the customer additionally deposit a collateral, when the guarantee money maintenance rate decreases under α=20%. Thus, according to the present invention, a risk is limited by compulsorily closing out before occurrence of additional deposit.

FIG. 7 depicts a flow chart describing the management method according to the present invention.

In step S1, the business computer 11 stores data of consignment guarantee money. More specifically, a customer who desires to start margin trading deposits the consignment guarantee money in the securities company 1 by the customer to satisfy the prerequisite condition. In response to this, the business computer 11 of this system 5 stores the amount of the consignment guarantee money.

In step S2, the business computer 11 stores the trading details. More specifically, the business computer 11 stores the trading details (trading content) including the agreed-upon price of the open position provided by margin trading using the money or the loan stocks rented from the securities company 1 by the customer. The business computer 11 applies respective details and values to the equations, pre-stored in the memory, corresponding to all types of trading. For example, if the trading is a short sale, respective details including the amount of loaned stock charge, the number of loaned (lent) stocks and details indicative of which issue of loaned stocks are sold and at which an agree-upon price the lent stocks are sold. Further, regarding the daily rate, the backwardation rate, and interest, dates and the number of days between the start of trading and the closing out are also applied to the equation.

In step S3, the business computer 11 collects stock price information. This process may continuously collect the renewed stock prices day and night. However, it is also possible to collect once a day, for example, at 4 p.m. to conform the collected information to the closing prices that will appear in news papers.

In step S4, the business computer 11 outputs results of calculations using the equation for calculating the unrealized profit and loss in consideration of the renewed stock price, an unsettled interest and/or unsettled loan (lent) stock charge or the like using the trading details stored in step S2.

In step S5, the business computer 11 calculates the guarantee money maintenance rate. More specifically, the guarantee money maintenance rate is calculated by applying renewed values of the consignment guarantee money, the agreed-upon price, and the profit and loss of the open position into the equation corresponding to the trade, in which the open position including stocks of an individual issue traded at the same price at the same day is dealt as the minimum unit of management.

In step S6, the business computer 11 extracts the open position to be managed to make the securities company 1 compulsorily execute closing out when the guarantee money maintenance rate agrees with any of threshold values set stepwise for the specified guarantee money maintenance rate for each open position. The stepwise threshold values of the consignment guarantee money mean a combination of, for example, the specified guarantee maintenance rate α=20% or multi-values higher than this value and a fixed value of β=0%.

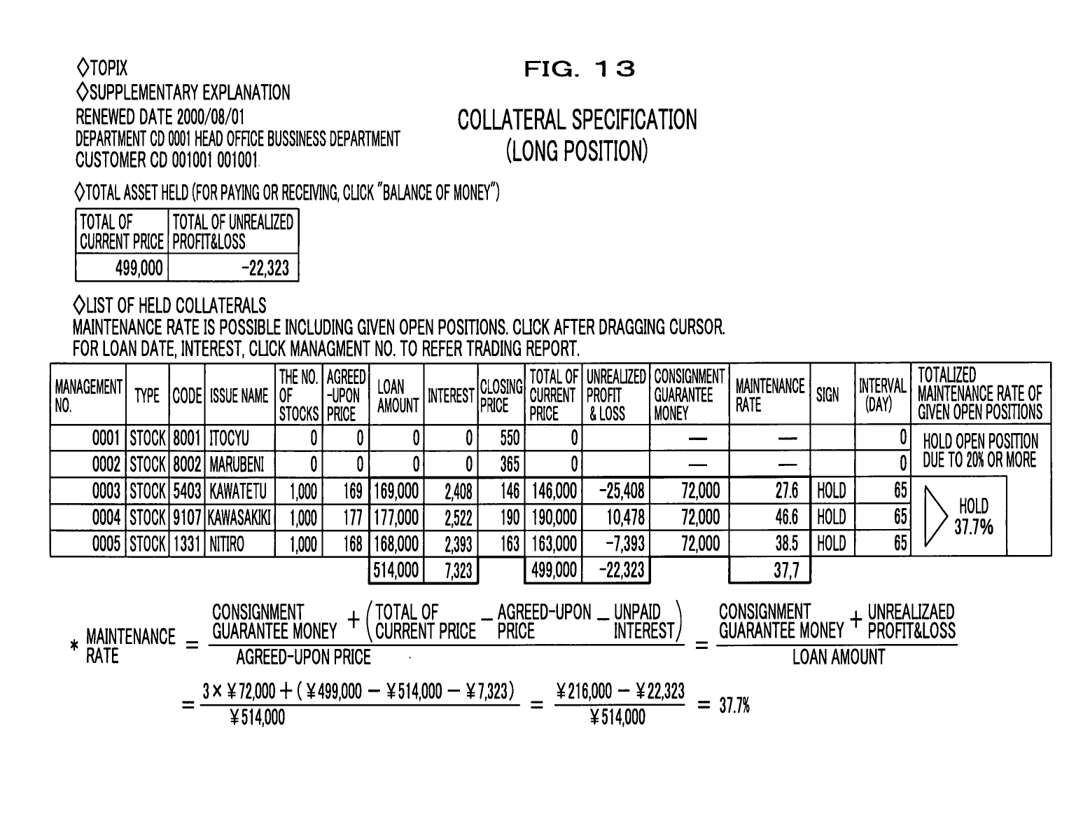

In step S7, the business computer 11 displays the managed open position extracted in step S6. More specifically, the business computer 11 distinctively displays the managed open position extracted to execute the closing out in step S6 at both securities company 1 and the customer (refer to FIG. 13 described later). For example, the closing out at the market is executed when the rate agrees with the specified money maintenance rate α=20% and the closing out outside the market is executed when the rate agrees with the specified guarantee money maintenance rate β=0%. That is, the securities company 1 acts as a buying party itself to execute the closing out, so that the open position to be subjected to the closing out is distinctively marked or listed on a book, specifications, or the like to indicate the open position. Further, if there is agreement, it is also possible that the target open position is displayed only at the securities company 1 in a real time manner and the customer is informed of this afterwards.

Next, will be described, a method of supplying the loan information 32, the loaned stock information 33, and profit and loss information 34 in a balance sheet (FIG. 9 described later) through the Internet 3 to a customer with reference to FIG. 8.

FIG. 8 depicts a flow chart illustrating an access procedure to this system 5 from a customer terminal 2.

First, a customer inputs its individual ID and the password into a customer terminal 2 to access the home page provided by the WWW server 3 to request a service in step S201. In response to the service request from the customer terminal 2, the WWW server 13 requests the business computer 11 to execute the service requested by the customer and authentication of the customer in step S202.

The business computer 11 collates, in step S203, the individual ID and the password included in the service request data transmitted from the customer terminal 2 with the individual IDs and the passwords previously registered in the storing section 22. The business computer 11 determines that the service request is from a regular customer only when there are agreements in collation results of the individual ID and the password (authentication) and then, executes a renewing process to renew the stock trading file 12 in step S204.

Here, this renewing process is omitted when the stock trading file 12 (FIG. 6) is renewed synchronously with the reception of the stock price information obtained from an external information providing agent (not shown) through the Internet 3.

In step S205, the business computer 11 transmits, out of data in the renewed the stock trading file 12, only the information to be described on the balance sheet 40 for the customer as home page information.

The WWW (World Wide Web Site) server 13 edits the information to be described on the balance sheet 40 transmitted from the business computer 11 to have the HTML (Hyper Text Markup Language) format to generate a renewed home page file 14 in step S206.

Next, the WWW server 13 transmits the balance sheet 40 in the HTML format to the customer terminal 2 in step S207. The customer terminal 2 has a browser function that interprets the information in the HTML format transmitted from the WWW server 13 that edits the balance sheet 40 to display it on the display screen in step S208. According to this procedure, the customer can refer to the balance sheet 40 shown in FIG. 9 on the screen of the customer terminal 2.

FIG. 9 is an illustration of the balance sheet 40 for managing a long position. In FIG. 9, at the balance sheet 40, the specification is conveniently generated for managing the long position from information regarding trading of stocks stored in the stock trading file 12. That is, the balance sheet 40 describes the consignment guarantee money 42, the amount of loan 43, an interest 44, a total of loan 45, an issue of the purchased stocks 46, the number of stocks 47, an agreed-upon stock price 48, a market capitalization 49, the recently renewed guarantee money maintenance rate 50, and maintenance rates α and β as the specified threshold values of the consignment guarantee money.

Here, when the maintenance rate α=20%, a reverse trade at the market (closing out) is compulsorily executed. When the maintenance rate β=0%, a reverse trade outside the market (closing out) is compulsorily executed. That is, the securities company 1 executes the closing out as a buying party itself.

Further, the format may include a presumed profit and loss or the like regarding the currently sold stocks.

The balance sheet 40 shown in FIG. 9 is formed to manage a long position in margin trading. However, this is only an example and may have another format. For example, the balance sheet 40 may have a calculation function to provide the total further including items for stocks purchased by cash or a short sale by margin trading. Still further, the balance sheet may be provided for every individual issue or a plurality of issues to be integrally shown.

Here, the present invention is provided particularly for supplying a computer system capable of services with reduced risk (loss cut) for a general customer. Thus, it is desirable that the balance sheet 40 has a clear and brief format. The balance sheet 40 may have a plurality of formats and one is occasionally selected from such formats.

Further, as the individual information of the customer, only the individual ID 41 is described in the balance sheet 40. That is, when the information including the balance sheet 40 is transmitted to the WWW server 13, after the business computer 11 generates or renews the stock trading file 12, the information regarding the name and address of the customer is not transmitted to prevent a third party from identifying the customer, but only individual ID 41 is transmitted.

Transmission of only the individual ID 41 ensures the obligation to keep official secrets and makes it easy to trust the business to an outside supporting agency (a subcontractor of the securities company 1) as described later with reference to FIGS. 12 and 16.

In this embodiment the business computer 11 is described as a separate element from the WWW server 13. This only describes a logical structure and thus, it may be provided with an integrated hardware element. Further, the WWW server 13 is installed within the securities company 1. However, the WWW server 13 may be provided in the structure of a server (not shown) in an Internet provider.

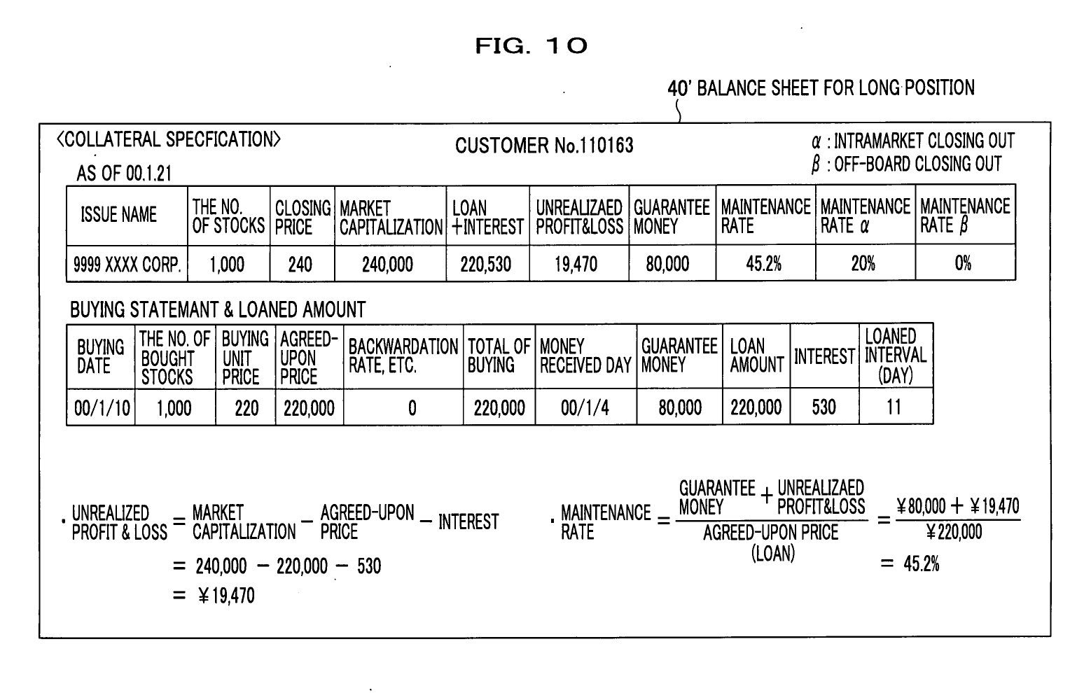

FIG. 10 is an illustration showing an example of a balance sheet for managing a long position.

In FIG. 10, there is shown only the individual ID indicating the customer visible to a third party, namely, the sheet is designated with a customer having identification code of “No. 110163”. This number was issued by the securities company 1 when the securities company 1 started the transaction with the customer to act the automatic loss cut requested by the customer and is secretly managed.

The information identifying the issue of the stocks is “issue name”, and the name of the issue company is described after its issue code defined in the stock market.

In this example, buying was once executed, and thus, the details are described as the loan information. Further, this information is described at a special page in a settlement account book for buying and selling (not shown) of the securities company 1. In this buying, the execution date is January 10, the number of stocks is 1000, the unit price is 220 yen, the total cost is 220,000 yen, and the loan (loan) amount is also 220,000 yen.

Further, an interest of 530 yen occurs for the amount of 220,000 yen loaned by the securities company 1.

For this buying trade, the customer applies consignment guarantee money of 80,000 yen on January 4.

The information indicative of profit and loss is further shown in the sheet. The stock price on January 21 is 240 yen as the closing price, so that the market capitalization is 240,000 yen. If a profit-taking selling was executed, the unrealized profit and loss would be as follows:
Unrealized profit and loss=Market capitalization−Agreed-upon price−Interest

$$\begin{matrix}Unrealized profit and loss \\ = Market capitalization - Agreed - upon price - Interest \\ \begin{matrix}\begin{matrix} = 240 , 000 - 220 , 000 - 530 yen \\ = 19 , 470 yen .\end{matrix} \\ The maintenance rate is further described as follows : \\ \begin{matrix}Maintenance rate = ( Consignment guarantee money + Unrealized \\ profit and loss ) \text{/} Agreed - upon price \\ = ( 80 , 000 yen + 19 , 470 yen ) \text{/} 220 , 000 yen \\ = 0.452 = 45.2 \%\end{matrix}\end{matrix}\end{matrix}$$

Here, the specified threshold value α=20% is provided for the maintenance rate to compulsorily execute the closing out at the market and the specified threshold value β=0% is provided for the maintenance rate to compulsorily execute the closing out outside the market. Since the maintenance rate is 45.2%, which is within the safe range, those long positions can be maintained.

On the other hand, if the maintenance rate reached α=20%, the stocks would be sold within the market. Further, though the stock could not be sold in the market, the securities company 1 would buy at a quotation price, when the maintenance rate reached β=0%.

FIG. 10 specifically shows the guarantee money maintenance rate (in the drawing), it is shown as “Maintenance rate”. First, a profit and loss is calculated from difference between the current price and the agreed-upon price in consideration of the unsettled interest, and/or the unsettled loaned stock charge or the like. The maintenance rate may be calculated with stock trading charge or the like (including tax) in addition to the loan interest and/or the loaned stock charge (not shown).

In order to respond to the customer's desire for precisely managing the risk, an indication is made to display that the maintenance rate reaches the threshold values at a smallest unit of managing the open positions traded at the same day at the same price for each issue. The threshold value a (which is denoted with maintenance rate a in the drawing) is the value defined by the contract between the securities company 1 and the customer. For example, if the maintenance rate reaches α=20%, the stocks will be sold within the market. Further, the securities company 1 executes the closing out by the relative trading of the stocks outside the market, when the maintenance rate reaches β=0%.

As mentioned above, the customer can access the home page to refer to the Home page to obtain the condition of loaned stocks, details of loan, the stock price of today, and the profit and loss when the stocks are currently sold for the long position. Here, a description about the balance sheet for managing a long position is omitted. However, it is also possible to calculate the maintenance rate similarly in consideration of unsettled loan stock charge or the like in addition to the unsettled interest.

A method of managing all open positions in a customer's account using margin trading with this system 5 will be described with reference to FIG. 11. FIG. 11 depicts a flow chart describing the method of management.

A renewing process of the stock trading file 12 will be described with reference to FIG. 11. The back office computer 100 successively executes the general business toward customers and the market in step S10. A customer knows a renewed stock price and then may decide the margin trading of stocks as well known.

This system 5 interchanges information with the back office computer 100 and with the customer in step S11. Thus, this system 5 renews the information on documents displayed on the screen of the customer terminal 2 in real time or daily in step S12 and as well as continues to calculate the guarantee maintenance rate.

In step S12, if there is an open position that is not subjected to the closing out, the interest (including loan stock charge), the profit and loss, and the maintenance rate are renewed. Further, on payment of the consignment guarantee money and at the start of transaction for buying or selling, the balance sheet 40′ shown in FIG. 10 is newly prepared to renew the information.

The renewing process in step S12 is carried out as shown in FIG. 8 in steps S201 to S208. When the renewed price information is received, the processes from steps S201 to S203 are omitted and the processes from steps S204 to S208 are directly executed to renew the indication. Similarly, on renewing the stock trading file 12 including the closing out, the processes from steps S201 to S203 are also omitted. In FIG. 11, for briefly describing the method of management, the renewing procedure is distinctively shown between the cases with the closing out and without the closing out.

After the calculation of the maintenance rate in steps S10 to S12, it is determined whether the calculated maintenance rate reaches the threshold value α=20% in step S13. If calculated maintenance rate reaches the threshold value α=20%, the information for the screen of the customer terminal 2 is renewed in step S14 and indicated in step S15 with a management open position indication in step S15. In addition, this system 5 sends a first instruction to the back office computer 100 in step S16 to compulsorily close out the stocks at the market and after this, confirms the execution of the closing out in step S17.

Here, it is assumed that the customer always monitors the recent information by the service request (S201) shown in FIG. 8 through an operation of the customer terminal 2. In other words, this system can exclude the case that a customer intending to trade stocks through the Internet 3 does not operate the customer terminal 2. Consequently, the customer is always noticed of the open position display in step S15.

If the result of confirmation in step S17 indicates a failure in the closing out at the market, on the basis of the first instruction in step S16, the back office computer 100 repeats the proposal for selling at the market to execute the closing out. Nevertheless the closing out cannot be established in step S17, the system 5 monitors whether the maintenance rate reaches the threshold value β=0% in step S18.

If the maintenance rate reaches the threshold value β=0% in step S18, the indication on the screen is renewed in step S19 to notice the condition with the managed open position indication in step S20. The system 5 sends a second instruction to the back office computer 100 in step S21 to execute the closing out by a compulsory reverse trade through a relative trading outside the market at the current indicative price in step S22. More specifically, the securities company 1 acts as a partner in the reverse trading and purchases the long position at the current selling indicative price.

Here, the closing out by execution of a compulsory reverse trading outside the market in step S22 was beyond the range of the general business of the securities company at the time of the filing date of the present invention. However, this system 5 executes the reverse trading in step S22 as mentioned above, renews the stock trading file 12 with the closing out in step S23, and provides the display of the renewed file in step S24.

On the other hand, if the closing out at the market on the basis of the first instruction in step S16 is established in step S17, the system 5 bypasses the step S18 and renews the stock trading file 12 with the closing out in step S23 and displays the renewed file in step S24.

Further, this system 5 also mediates between the customer and the market through the general business process shown by step S10. Thus this system 5 does not interfere with the general business.

More specifically, in this system 5 stock prices are renewed at any time or intermittently, for example, once a day, always (night and day), or periodically, for example, at 4 p.m. every day, so that the stock prices over the world or at the specified market, for example, Tokyo stock market are monitored.

This system 5 directly or indirectly sends to the securities company 1 an instruction of closing out for individual open position of which maintenance rate calculated using renewed recent stock price reaches the threshold values a or P. The instruction of the closing out may be made irrespective of whether the process is unmanned or manned as long as the process is uniquely executed with exclusion of the personal feelings and/or intentions of the persons concerned.

Just after midnight (0 a.m.), interests and the loan stock charge per diem are renewed, and stock prices are renewed during daytime of weekdays, and thus the maintenance rates are renewed with these changes.

As mentioned above, when the guarantee money maintenance rate is equal to or less than the threshold values α or β, the securities company 1 can print out the information including results of the closing out or describe the notice on the balance sheet 40 and automatically notice a customer of it through the Internet 3 and mails.

More specifically, the WWW server 13 is made to have a mail server function to store individual IDs and mail addresses of customers, and the business computer 11 transmits individual IDs and corresponding information to the WWW server 13 to automatically transmit electronic mails from the WWW server 13 to the customers having mail addresses corresponding to the individual IDs.

Further, the operation program executes the renewal of the stock trading file 12 synchronously with the reception of the stock price information obtained through the Internet 3 from an external information providing agent (not shown), at a predetermined time of the predetermined day, or in response to a service request in step S201 from a customer terminal 2 shown in FIG. 8, or in response to the combination of these operations.

In addition, the operation programs for executing various types of calculation processes, the display processes, and the rewriting process of the stock trading file 12 are stored in the storing section 22 shown in FIG. 5 and executed at the processing section 21. This provides the profit and loss calculation section 64, the maintenance rate calculation section 65, and the management open position extraction section 67 in the processing section 21.

The threshold values a and p for the guarantee maintenance rate can be inputted with the input section 25 of the business computer 11 to change the values to optional values to store them in the storing section 22. When the guarantee maintenance rate is equal to or greater than the threshold values α and β, the display section 24 displays the information indicative of this fact.

Further, the operation program can input the loan information and the profit and loss information regarding stock trading by the operation to the customer terminal 2 or the input section of the business computer 11 to execute the calculation process for each issue or each open position. In addition, the operation program can execute the calculation processes for a plurality of issues or a plurality of open positions integrally. Further, according to this operation program, the stock trading can be effected for each stock, for each issue of open position, for a plurality of issues of stocks integrally, or for a plurality of open positions integrally.

FIG. 12 is a functional block diagram of the system adapter 10. The system adapter 10 includes an identification code generation section 81 for generating an identification code corresponding to each customer, a customer coding section 82 for removing the customer identifying information capable of identifying the customer from the trading information shared by the securities company 1 and the customer and for adding the identification code to the trading information instead of it, and a search and reference section 83 for providing searching and referencing the trading information openly to a third party with the identification code being used as a searching mark. In addition, the system adapter 10 includes a given open position totalizing section 84, the management open position extraction section 67 mentioned above, a managed open position display section 68, and a notifying section 85 for notifying a customer of the managed open position to improve the convenience.

The system adapter 10 shown in FIG. 12 provides an identification code generation step of generating an identification code corresponding to each customer, a customer coding step of removing the customer identification information capable of identifying the customer from the trading information shared by the securities company 1 and the customer and, instead of the removed information, adding an identification code to the trading information, and a search and reference step for providing searching and referring the trading information open to a third party using the identification code as a searching mark.

In addition, the system adapter 10 provides a given open position totalizing step of totalizing the guarantee maintenance rates of selected given issue or open position and a third instruction step of instructing the closing out for only the given open position at the maintenance rate totalized by the given open position totalizing step (FIG. 13 mentioned later).

Next, the operations and effects of this system 5 will be described with reference to FIGS. 4 to 12 from the point of view of users (customers and the securities company 1). First, a customer contracts with the securities company 1 for stock margin trading through a teller or using the Internet. On contraction, the securities company 1 issues a password to the customer for the use of the Internet.

The individual ID and the password are unique numbers. When the individual ID and the password are registered in the storing section 22 of the business computer 11 at the securities company 1, the customer is conditioned to use this system 5. The contract is established as follows:

Rules previously prepared by the securities company 1 are displayed on the screen for the customer 2 and then, the contract is established by an operation for agreement about the rules, wherein it is sufficient that a trace of agreement is left in data. If there is no operation for agreement, the contract procedure screen image inhibits to proceed to the next procedure. Once the contract is established, this contract cannot be cancelled until the completion of the trading.

Upon the contact, the customer previously registers a threshold value equal to or higher than α=20%. Further, the minimum unit of management is stocks traded at the same agreed-upon price on the same day for each issue. However, it is possible to contract to integrally manage the stocks of the same issue (FIG. 13 later described).

When the customer tries to acquire the loan information and the profit and loss information using this system 5, the customer access the home page in the WWW server 13 at the securities company 1 from the customer terminal 2 to request services by inputting the individual ID and the password.

When receiving the service request from the customer terminal 2, the WWW server 13 requests the business computer 11 to respond the service request from the customer and to identify the customer. The business computer 11 collates the individual ID and the password included in the service request data transmitted from the customer terminal 2 with the individual IDs and the passwords previously registered in the storing section 22.

The business computer 11 judges that the service request is from a regular customer only when the collation result therebetween indicates agreement and starts the renewing process of the stock trading file 12 toward the recent condition.

The business computer 11 executes an interest calculation on the basis of the interest with the financing day being handled as an initial date, a profit and loss calculation for adding the interest to the amount of the loaned money, a market capitalization for multiplying the number of stocks by the stock price information obtained from an external information providing agent (not shown) through the communication control section 23 and the Internet 3, and a guarantee money maintenance rate calculation for dividing the profit and loss by the market capitalization. Then, the business computer 11 rewrites the details in the stock trading file 12 with these calculation processing results as the latest information and terminates the renewing process.

Further, the business computer 11 transmits only the information described in the balance sheet 40 to be provided to the customer from the renewed stock trading file 12 to the WWW server 13. The WWW server 13 edits the information to be described in the balance sheet 40 transmitted from the business computer 11 to have a HTML format to generate or renew a homepage file 14.

Next, the WWW server 13 transmits the balance sheet 40 in the HTML format to the customer terminal 2. The customer terminal 2 interprets the information having the HTML format transmitted from the WWW server with the built-in browser function to display the balance sheet 40.

When the maintenance rate reaches the threshold value a or as a result of the maintenance rate calculation process in the business computer 11, a notice is displayed at the display section 24 thereof to indicate that the maintenance rate reaches, for example, α=20% and the same notification is also described on the balance sheet 40. It is preferable to blink the corresponding section with color to notice this fact on the screen. The customer and the securities company 1 execute the closing out at that instance, for example, by selling the stocks at the market, so that the risk possible on decrease in the stock price can be limited.

If the stocks have left unsold and the maintenance rate reaches β=0%, an indication of buying the stocks is made, and the stocks are purchased by the securities company 1 or an agent specified by the securities company 1 from the customer. This makes the loss amount equal to the consignment guarantee money to prevent the generation of loss greater than the consignment guarantee money.

When accessing the home page in the WWW server 13 by inputting its individual ID and the password to the customer terminal 2, the customer can monitor the balance sheet 40 (FIG. 9). The actual balance sheet 40′ is as shown in FIG. 10.

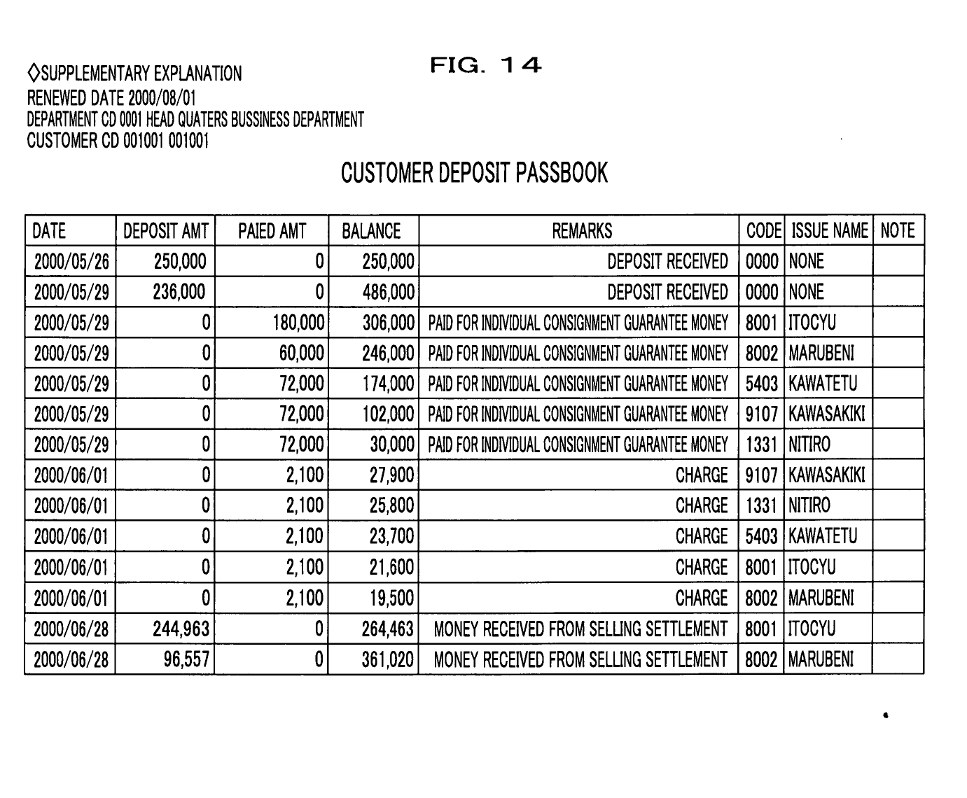

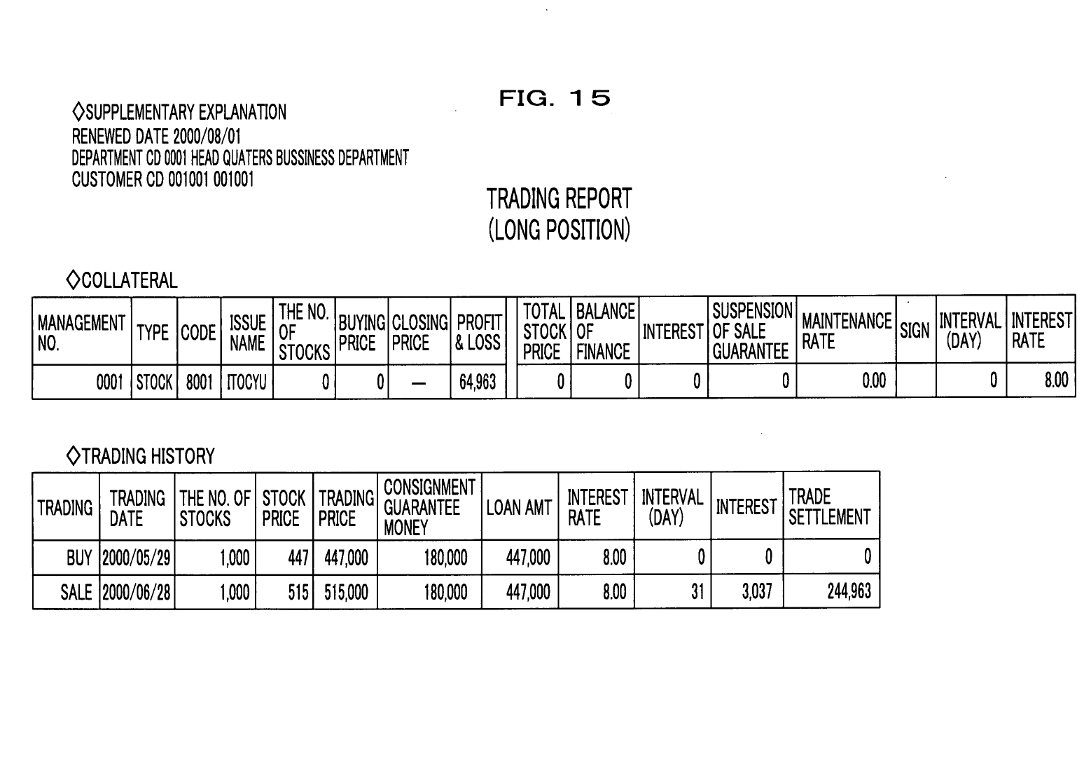

Next, modifications will be described with reference to FIGS. 12 to 24. FIG. 12 is the functional block diagram of the system adapter. FIG. 13 is a collateral specification for managing a long position. FIG. 14 shows an example of a customer deposit passbook. FIG. 15 is an example of a trading report for managing a long position. FIG. 16 shows a modification, wherein the system adapter 10′ is provided in an external supporting agent.

The system adapter 10 includes, as shown in FIG. 12 and described with FIGS. 4 and 11, the managed open position extraction means 67 and the managed open position display section 68 as a core thereof, and further the identification code generation section 81, the customer coding section 82, the searching and referring section 83, the given open position totalizing section 84, and the notifying section 85.

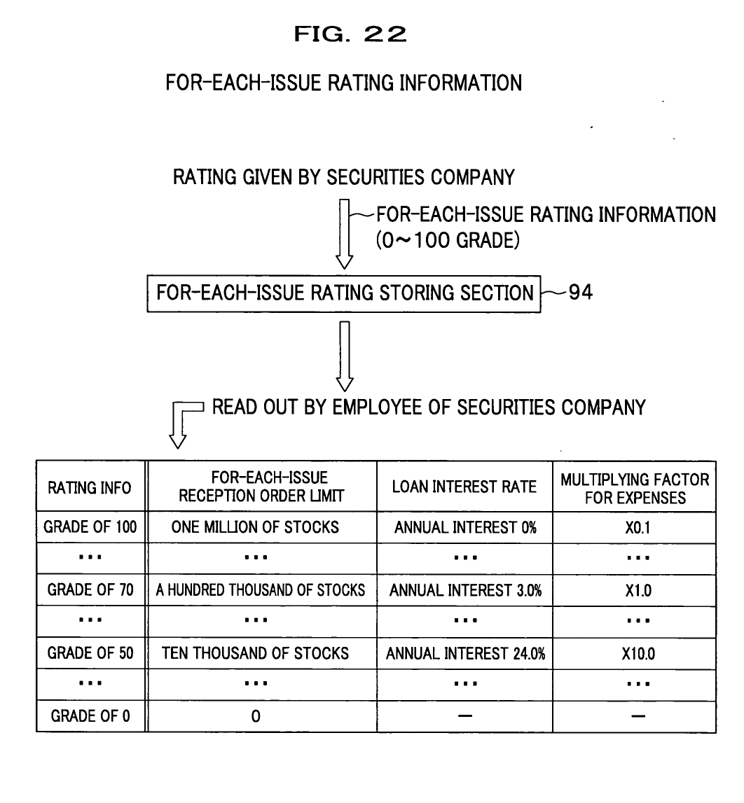

Further, the system adapter 10 may optionally include a for-each-issue rating storing section 94 mentioned later with reference to FIG. 22.

The identification code generation means 81 generates an identification code corresponding to each customer. More specifically, the identification code generation section 81 includes a serial number generation program secretly managed and a memory of which data is not open. Then, the identification code generation section 81 replaces the customer's identification information capable of identification of the customer in the trading information shared by the securities company 1 and the customer with the identification code to provide convenience in management of the customers.

In other words, the name or the like of the customer is hidden and the management is carried out with only identification codes, so that a third party cannot check the name against the identification number.

On the other hand, the searching and referring section 83 allows a third party to refer freely to the trading information using the identification code as a searching mark to permit the Internet stock trading.

The given open position totalizing section 84 totals the guarantee money maintenance rate of the selected given issues or given open positions (FIG. 13). The given open position totalizing section 84 is coupled to a third instruction section for instructing the closing out directed to a combination of the corresponding given open positions in accordance with the totalized maintenance rate as shown by the table and the equation in FIG. 13 to manage open positions along the reasonable management concept in accordance with the result of totalizing of the guarantee maintenance rate for given open positions optionally selected by the customer.

This structure provides a margin in operation because the threshold value storing section 66 (FIG. 5) can store any given values as stepwise threshold values a which is equal to or greater than α=20% (FIG. 10). Thus, if the totalized guarantee maintenance rate reaches the threshold value α=20%, the corresponding open positions are subjected to the closing out though any open position as the minimum unit does not reach the threshold value α=20%.

Alternatively, the customer can contract with the securities company 1 to execute the closing out when any of open position as the minimum unit reaches the threshold value α=20% though the totalized guarantee maintenance rate does not reach the threshold value α=20%.

This provides to the customer a chance of an earlier closing out than the timings of the value reaching the threshold values α and β though it is inhibited to suspend the closing out in accordance with the customer's intention in this system. This is because the earlier closing out by the customer's intention is free.

For example, it is assumed that the customer purchased stocks of an issue at different prices as a plurality of open positions. When a part of a plurality of open positions that were bought at high prices reaches the threshold values α and β, but the remaining part does not reach the threshold values α and β, the customer can execute the closing out for all open positions in accordance with the intention of the customer or the contract.

Here, it is reasonable that this judgment is left to the given open position totalizing section 84 for totalizing the guarantee maintenance rates from the selected given issue or open positions and to the third instruction section for instructing the closing out directed only to the given open positions corresponding to the totalized maintenance rate totalized by the given open position totalizing section 84.

Totalizing the guarantee money maintenance rates at the given open position totalizing section 84 is provided by agreement of the rules by the customer, including selection criterions for selecting open positions, prepared by the securities company 1.

As shown in FIGS. 13 to 15, the securities company 1 manages open positions with three types of specifications, namely, “Collateral Specification (Long Position)”, “Customer Deposit Passbook”, and “Trading Report (Long Position)”. These specifications are prepared for each customer and can be monitored using the Internet 3 day and night. When referring to these specifications, a customer inputs its individual ID and the password to access its own trading page.

The “Collateral Specification” is for indicating the deposited stocks as collateral. In the specification, out of the management numbers 0001 to 0005, two issues with numbers of 0001 and 0002, namely, “ITOCYU” and “MARUBENI”, were sold on June 28 (FIG. 14), so that they are outside the target of collateral. This means that they can be perfectly erased from the specification. However, their histories of selling are indicated with a mark of “0” or “−”.

A thousand of stocks of three issues, i.e., “KAWATETU”, “KAWASAKIKISEN”, and “NITIRO” having management numbers 0003 to 0005, respectively, are being kept as collateral and subjected to the management of open positions at the specified guarantee maintenance rate.

For three issues of open positions having management numbers 0003 to 0005, the maintenance rate is calculated with at least given one of open positions having the management numbers 0003 to 0005. If the calculated maintenance rate is higher than, for example, 20% (inclusive according to the contract), the open positions are maintained. If the maintenance rate is equal to or lower than 20%, a notice of the closing out is displayed. In the example shown in FIG. 13, the maintenance rates are 27.6%, 46.6%, and 38.5%, respectively, and the total maintenance rate is 37.7%. Thus, the open positions are kept in any combination of them.

If the contract defines that a maintenance range above the threshold value includes 20%, when the calculated maintenance rate is equal to or higher than 20%, the open positions are maintained. If the maintenance rate is lower than 20%, the notice of the closing out is displayed.

In the “Collateral Specification” shown in FIG. 13, the columns of “maintenance rate”, “sign”, and “given open position totalized maintenance rate” act as the managed open position display section 68. This system continues to calculate and monitor the maintenance rates day and night instead of the customer. When the maintenance rate reaches the predetermined threshold values α and β, an indication “maintain” is changed to “closing out”.

Further, the indication of the managed open position is identified by the indication notifying that the guarantee money maintenance rate reaches the threshold value α or β. For example, other indications can be used such as a numerical indication, a different color indication, a separate list, and an electronic data capable of easy transmission.

The customer deposit passbook shown in FIG. 14 is a specification indicating reception and payment history accompanied with stock trading. The trading report shown in FIG. 15 is a specification indicative of trading stocks. The specifications shown in FIGS. 13 to 15 are prepared specially for long positions. Thus, it is preferable to prepare different suitable specifications for short-sold open positions.

The “Passbook” shown in FIG. 14 indicates a payment of 250,000 yen on May 26, a payment of 236,000 yen on May 29 as the consignment guarantee of money from the customer. The customer purchased on May 29 stocks of five issues “ITOCYU”, “MARUBENI”, “KAWATETU”, “KAWASAKIKISEN”, and “NITIRO”, and there are payments for the consignment guarantee money from respective issues of stocks, so that the balance becomes 30,000 yen. On June 1, a charge is paid for the securities company 1, so that the balance becomes 19,500 yen. After this, on June 28, there are payments caused by selling the stocks of “ITOCYU” and “MARUBENI”, so that the balance becomes 361,020 yen.

Further, for the management of a short selling open position with loan stocks according to margin trading, because the securities company 1 keeps all short selling payment as collateral deposition in the securities company 1, the passbook should be separately prepared or described on a collateral specification as shown in FIG. 13. However, a description of the short selling payment on the collateral deposition passbook is omitted because it is only question of indication.

The trading report shown in FIG. 15 indicates histories of the issue of “ITOCYU” regarding the buying on May 29 and the selling on June 28. More specifically, a thousand of stocks were purchased at 447 yen with a total of 447,000 yen. Since the whole payment was loaned, the amount of loan was 447,000 yen. Further, the consignment guarantee money of 180,000 yen was deposited.

After that, a thousand of stocks were sold at 515 yen. Since the whole payment was loaned, the amount of loan was 447,000 yen. Further, the consignment guarantee money of 180,000 was deposited. The settled account of this trading was 244,963 yen obtained by adding the consignment guarantee money 180,000 yen to the trading value of 515,000 yen and subtracting the amount of loan and the interest of 3,037 yen from the additional result. Thus, the profit and loss by the margin trading of the issue “ITOCYU” becomes 64,963 yen by subtracting the consignment guarantee money from the settled account of 244,963 yen.

In addition, the settled account of 244,963 yen for the stocks of “ITOCYU” is described on the deposition passbook at the second row from the bottom as shown in FIG. 14. Further, at the bottom row, the settled account of 96,557 yen for the stocks of “MARUBENI” is described. These settled accounts of 244,963 and 96,557 yen include 180,000 and 60,000 yen, which were individual consignment guarantee money, respectively, because they became unnecessary for the securities company 1 and thus, they are refunded.

This is because a profit-taking trade was succeeded as the result of the margin trading and, the interest and the charge were settled, the consignment guarantee money of 180,000 and 60,000 yen should be refund for the customer from the securities company 1.

For other issues of stocks the results are also reported on the deposition passbook (FIG. 14) and on the trading report (FIG. 15) at each trading. The collateral deposition specification in FIG. 13 indicates the current deposition condition (the asset condition including the consignment guarantee maintenance rate) for all issues of stocks traded.

In the collateral deposition specification shown in FIG. 13, the stocks of issues “ITOCYU” and “MARUBENI” have been sold on June 28 (FIG. 14), and thus, the profits and losses (established parts) are total of 101,520 yen obtained by adding 64,963 yen to 36,557 yen (not shown). Further, the profits and losses of the kept stocks of “KAWATETU”, “KAWASAKIKISEN”, and “NITIRO” are a total of −22,323 yen. Here, the unrealized profit and loss of each open position can be obtained by (closing price−agreed price)×the number of stocks−the interest.

As mentioned above, the customer can refer to the specification of the customer's deposit account and payment (FIG. 14), the trading history (FIG. 15), the collateral stocks (FIG. 13), and/or the asset condition of short selling in real time by accessing the home page. However, illustrating the asset condition of short selling in a drawing is omitted.

FIG. 16 illustrates the example where the system adapter 10′ is installed at an external supporting agent (subcontractor). That is, the system adapter 10′ is installed at a subcontractor or the like and coupled to the back office computer system 100 through the interface 30′ at the securities company 1′. The interface 30′ includes services at windows, telephones, FAX, and Internet 3. Alternatively, it is also possible to consider this part as a unit corresponding to the Interface 30′ installed at a department so-called call center.

Further, this invention is not limited to the above-described embodiment and can be variously modified. For example, the system adapter 10′ can be built in the back office computer 100.

Still further, because the respective processes in the present invention can be replaced with manual processes, so that the system adapter 10 and 10′ can be provided by operations of specialists or the like.

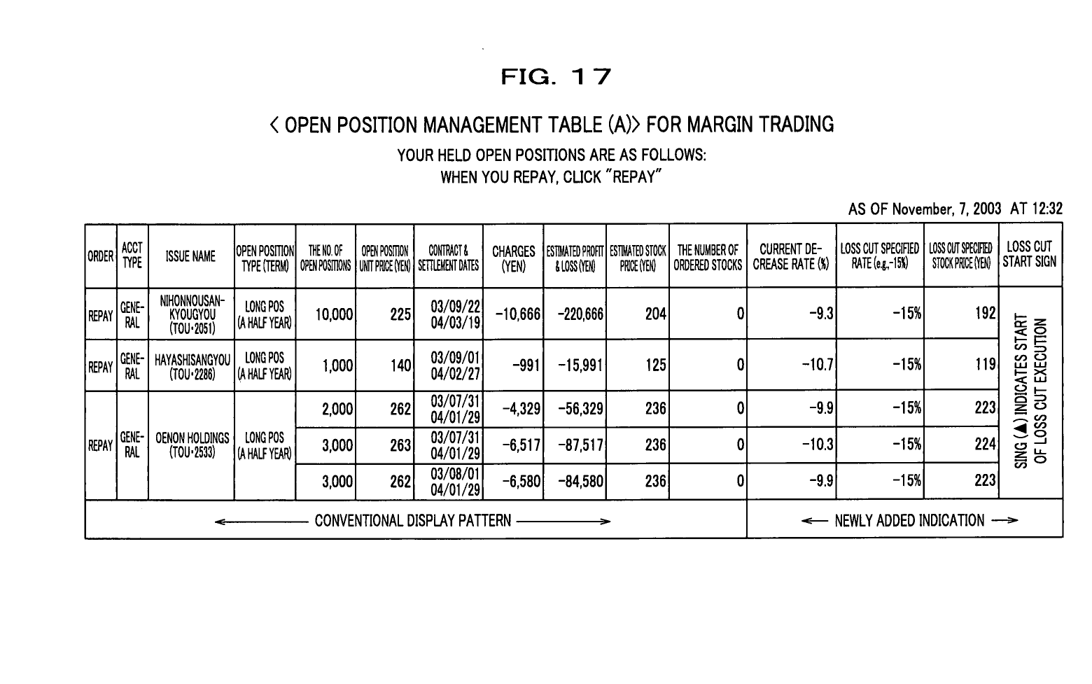

FIG. 17 shows an open position management table (A) using margin trading.

FIG. 17 illustrates, in addition to a general description of the margin trading for each open position of the customer, there is shown at least one of the loss cut specified rate (including the calculation method) determined by the customer and the securities company 1, the loss cut specified price calculated by the loss cut specified rate calculation method, a value for judgment as to where the current estimated stock price positions with respect to the loss cut specified rate, and the sign indicative of the start of loss cut by the securities company when the estimated stock price reaches the loss cut specifying stock price. The estimated stock price may use the current stock price, or the closing price or the like in accordance with the rule determined by the customer and the securities company 1.

The table indicates the profit and loss condition of the open positions held by a customer in real time. The customer purchased 10,000 stocks of “NIHONNOUSANKOUGYOU” at 225 yen on Sep. 22, 2003 and holds the open position with a time limit of Mar. 19, 2004, which is one day before the expiration of the subsequent half year.

At 12:32 on Nov. 7, 2003 (hereinafter time will be omitted), the estimated profit and loss is −220,666 yen because the loss of 210,000 is derived from the decrease in stock price to 204 yen and the reception and payment charge is 10,666 yen. The decrease rate at this instance is 9.3%={(204−225)/225}%).

Here, if it is assumed that the decrease rate for compulsory closing out, namely, the specified rate for the loss cut, is 15%, the table indicates as follows:
Stock price for loss cut={(100−15)/100}×225=191.2.
Then, the result is round up to have 192 yen, which was calculated at the time when the stocks were purchased on Sep. 22, 2003. This is indicated at the first and second columns from the rightmost of the open position management table (A).

The specified rate for the loss cut of 15% is only an example and can be optionally set by the contract (regarding the presence or the value), but cannot be changed before closing out.

At this stage where the stock price of the stocks purchased at 225 yen decreases to 204 yen, the stock price is higher than the specified stock price for the loss cut of 192 yen, and thus, the open position is maintained. However, when the stock price decreases down to or under 192 yen, a loss cut execution sign ▴ is immediately displayed at the rightmost column of the table.

FIG. 17 shows an example of a display (indication) provided by the open position management system for each open position, wherein the management is evenly executed to each open position in the account of a customer for stock margin trading. That is, the notifying section 85 displays the loss cut execution sign ▴ and the stock price of 192 yen for compulsory selling (opposite to buying) at the market by the securities company 1 to execute the automatic loss cut for each open position requested by the customer at the column of the table capable of displaying information at a unit (for frame) as long as the trading is the same issue, on the same day and at the same price.

Here, when the loss cut execution sign ▴ is displayed, as described with FIGS. 7 and 11, this system 5 sends an instruction of execution of the closing out to the back office computer 100. Then, the back office computer 100 sells 10,000 stocks of “NIHONNOUSANKOUGYOU” at the market as instructed. If the selling is established at 192 yen, the stocks are subjected to the loss cut at an estimated profit and loss of 220,666 yen, so that expansion of the loss can be prevented.

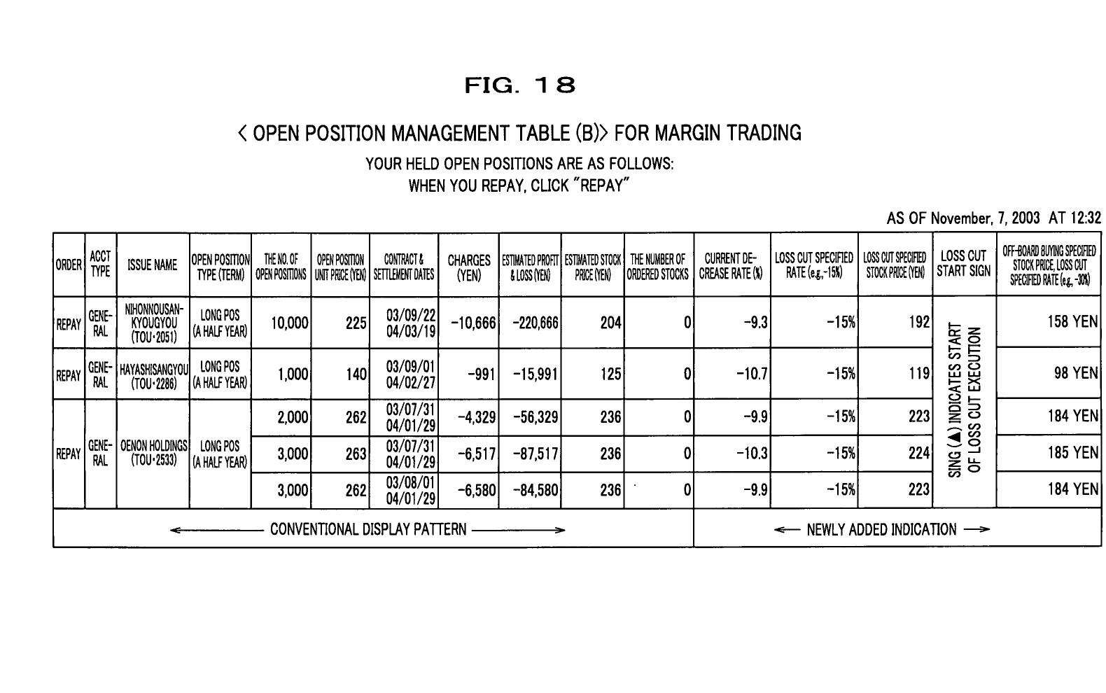

FIG. 18 is a held stock management table (B), a large part of which is the same as that of FIG. 17. Thus, a description of the overlapped part is omitted, but the rightmost column having a difference will be described.

This table describes, in addition to the table (A) shown in FIG. 17, an off-board transaction loss cut specified rate for each open position.

In FIG. 18, the stock price of reverse trading outside the market with a partner of the securities company 1 or a third party specified by the securities company 1, namely, the specified stock buying price outside the market of 158 yen is calculated using the loss cut specified rate of 30% and is given by:
Loss cut specified stock price={(100−30)/100}×225=157.5.
Then, the result is round up to have 158 yen, which was calculated at the time when the stocks were purchased on Sep. 22, 2003. This is indicated at the rightmost of the open position management table (B).

The specified rate for the loss cut of 30% is only an example and can be optionally set by the contract, but cannot be changed before the closing out or the completion of the contract.

At this stage where the stock price of the stocks purchased at 225 yen decreases to 192 yen, the loss cut execution sign ▴ is immediately displayed at the rightmost column of the table and the closing out at the market is instructed. However, if there is no buying party for 10,000 stocks of “NIHONNOUSANKOUGYOU” at the market, and when the stock price decreases to 158 yen, the securities company executes a reverse trade outside the market with the securities company 1 itself or the third party specified by the securities company 1 according to the contract. That is, the closing out is compulsorily executed by buying the 10,000 of stocks at 158 yen by the securities company 1 or the like.

As shown in step S21 of FIG. 11, the closing out is executed by sending the second instruction and the processes before and after the execution are the same as those described with reference to FIG. 17. However, without using the concept of “maintenance rate” but only the “loss cut specifying rate” and “loss cut specifying stock price” are used here for the criterion of the closing out.

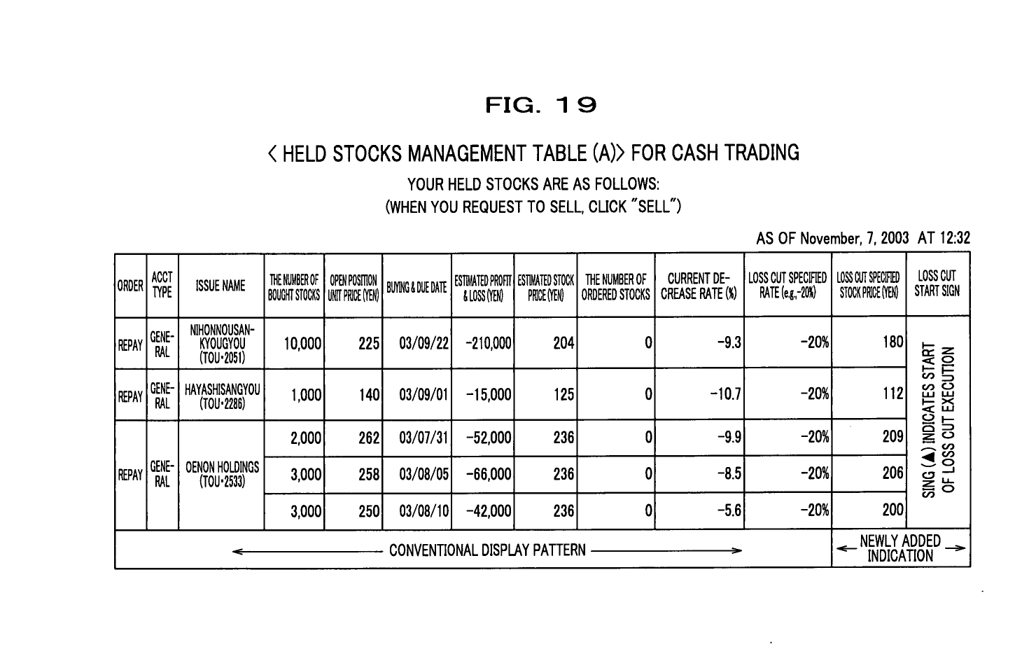

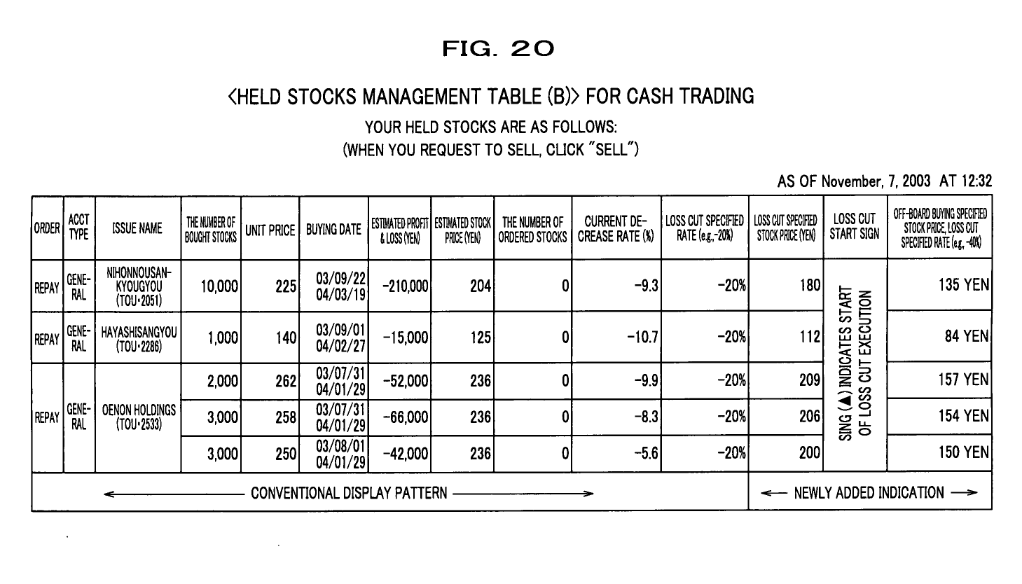

Next, an example of operation for the cash trading according to the present invention will be described with reference to FIGS. 19 and 20. The present invention provides a trading limited to the cash trading with “a held stock management system with a loss cut function, at a specified rate for each stock, uniformly executed for all stocks in the customer's account”.

FIG. 19 shows a cash trading held stock management table (A).

FIG. 19 illustrates, in addition to a general description of the margin trading for each held stock of the customer, there is provided at least one of the loss cut specifying rate (including the calculation method) determined by the customer and the securities company 1, the loss cut specifying price calculated by the loss cut specifying calculation method, a value for judgment as to where the current estimated stock price positions with respect to the loss cut specifying rate, and the sign indicative of the start of loss cut by the securities company 1 when the estimated stock price reaches the loss cut specifying stock price. The estimated stock price may use the current stock price, or the closing price or the like in accordance with the rule determined by the customer and the securities company 1.

FIG. 20 shows a cash trading stock management table (B). Since most parts of FIGS. 19 and 20 are the same as that of FIG. 17, and a large part of FIG. 19 is included in FIG. 20, only four columns from the rightmost of the table in FIG. 20 will be described. This table in FIG. 20 describes, in addition to the table (A) shown in FIG. 19, a loss cut specified rate outside the market for each open position.

If it is assumed that the loss cut specifying rate is set 20%, the stocks are subjected to the closing out when the stock price decreases down to 180 yen, which is calculated as follows:
Loss cut specified stock price={(100−20)/100}×225=180 yen

The price of 180 yen is calculated when the stocks were purchased on Sep. 22, 2003 and described at the third column from the rightmost of the table (B).

Further, a method of calculating a stock price for reverse trading with the securities company 1 or the third party specified by the securities company 1 outside the market, i.e., calculating the off-board (outside the market) buying specifying stock price of 135 yen using the loss cut specifying rate of 40% as follows:
Cut loss specifying stock price={(100−40)/100}×225=135 yen

The price of 135 yen is calculated when the stocks were purchased on Sep. 22, 2003 and described at the first column from the rightmost of the table (B).

Here, the value of “40%” is only an example and can be set in accordance with the contract, but cannot be changed before execution of the loss cut or the completion of the contract.

After that, when the stock price of the stocks purchased by the margin trading decreased to 180 yen, the execution start sign ▴ is indicated. Further, if 10,000 stocks of “NIHONNOUSANKOUGYOU” cannot be sold at the market though the instruction for the closing out at the market was made, and the stock price continues to decrease, the securities company 1 compulsorily executes the closing out by executing a reverse trading with the securities company 1 itself or a third party specified by the securities company 1 when the stock price decreases to 135 yen in accordance with the contract.

The held stock management table (A) shown in FIG. 19 and the held stock management table (B) shown in FIG. 20 act as parts of the held stock management system with the loss cut function at a specified rate for each stock uniformly executed to each stock within a customer account including a display section for displaying at least one of a first indication of the loss cut specifying stock price of 180 yen for instructing a compulsory intra-market selling when the price decrease rate exceeds a first rate of 20% and a second indication of the loss cut specifying stock price of 135 yen for instructing a compulsory off-board (outside market) selling when the price decrease rate exceeds a second rate of 40% at a display area capable of integrally displaying information of the stocks as long as the stocks have the same issue and the same price.

The various types of management tables shown in FIGS. 17 to 20 are different from those shown in FIGS. 13 to 15 in whether the concept of “maintenance rate” is used.

More specifically, the open position management with the maintenance rate provided in consideration of interests of the money or loan stock loaned from the securities company 1 by margin trading has been described with reference to FIGS. 13 to 15. On the other hand, the management tables shown in FIGS. 17 to 20 manage only the decrease rate for the compulsory closing out, namely, the loss cut specifying rate.

The tables shown in FIGS. 19 and 20 are for managing the held stocks purchased by the customer's resource without loan from the securities company 1. Thus, though the stocks were purchased on different days, it is clear to manage these stocks in the same group if the acquisition values are the same.

FIG. 21 is an illustration describing a relative transaction outside the market with the back office computer system 100′. The securities company 1 processes the general business with the back office computer system 100′, which can deal with actions to the market 80 for transactions with customers 20 and with reporting to Japan Securities Dealers Association 93.

The system adapter 10 (refer to FIGS. 4, 12, and 15) is coupled to the back office computer system 100′ to share information therebetween. In actual, this system may be provided by the back office computer 100′, a part of which acts as the system adapter 10 with a program stored therein.

The back office computer 100′ can actually execute processes in response to the first instruction (S16) and the second instruction (S22) issued from the system adapter 10 without delay. Thus, the back office computer system 100′ has software, hardware, and information for providing the general business processing functions for the securities company 1, in addition to the functions of the first and second instruction sections.

The first instruction (S16) issued from the system adapter 10 indicates a compulsory reverse trading at the market 80 executed only by the computer processing irrespective of a request or an indication of agreement from the customer.

More specifically, the securities company 1 manages the details of transactions with the customer 20 with books using the back office computer system 100′, and thus, the compulsory reverse trading can be executed at the market on the basis of the first instruction (S16) by renewing the data file forming the books. As described-above, the stock trading by the computer management means the changing operation toward the books on which the parties concerned rely and thus, the compulsory reverse trading can be executed only by renewing the stock trading file 12 (refer to FIG. 4).

In addition, the second instruction (S22) similarly issued from the system adapter 10 is transmitted to the back office computer system 100′ without delay and then, the back office computer system 100′ executes a relative transaction outside the market with the relative transaction execution section 91 provided in the back office computer 100′.

The relative transaction execution section 91, for example, tries to make a specific partner purchase at an indicative price the stocks that are failure in closing out because they were unsold at the market 80 due to no buying party. Here, because the securities company 1 purchases the stocks, the relative transaction execution section 91 can complete the relative transaction only by renewing the stock trading file 12 like the books in the back office computer system 100′ are changed.

A notifying section 92 in the back office computer 100′ informs, within five minutes, Japan Securities Dealers Association 93 as administration agency of the execution of the relative transaction.

Further the relative transaction execution section 91 can be considered as an inside or outside supporting agent 79 as a lower organization of the securities company 1. In this case, the system adapter 10 including the business computer 11 and the stock trading file 12 (books) shown in FIG. 4 is coupled to the back office computer 100 to share information therebetween through the interface 30 (omitted in FIG. 21).

As mentioned above, the system adapter 10 or 10′ and the back office computer 100 or 100′ coupled to each other provide a computer system allowing the securities company 1 to act for the customer 10 to uniformly execute the loss cut for each stock, which was considered to be difficult for the customer, not a specialist, to execute the loss cut only with its intention.

FIG. 22 is an illustration of dealing rating information for each issue. The rating information for each issue is stored for searching by the members (employees) of the securities company 1 through a for-each-issue rating storing section 94.

The for-each-issue rating storing section 94 is provided in the storing section 22 of the business computer 11 (refer to FIG. 4) included in the system adapters 10, and 10′, so that it is immediately readable and writeable. However, it is sufficient that the for-each-issue rating storing section 94 is coupled to or built in the back office computer 100 or 100′ through some connection means.

In addition, the persons allowed to write the individual issue rating information are limited to qualified persons who are correspondingly entitled in the securities company 1, in which the security is managed with passwords or the like to protect the stored rating information from illegal actions such as vicious manipulation. On the other hand, it is better to permit everyone to read and display the stored individual issue rating information by a simple operation at the terminal or the like provided within the securities company 1.

The securities company 1 rates stocks for each issue within the range from 0 to 100 grades and registers them in the for-each-issue rating storing section 94, which is suitably renewed. The securities company 1 is allowed to apply an operation standard, which is advantageous to the securities company 1, to the rating standard.

The individual issue rating information includes, as shown in FIG. 22, for-each-issue reception order limits, loan interests, and rates of expenses, which correspond to the rating information. This determines the ratio between the securities company 1 and the customer in the risk taking and expenses in trading stocks.

Further, the expenses may be multiplied by the multiplying factor for expanse with the trading charges or the loaned stock charge or the like.

For each piece of individual issue rating information, a for-each-issue reception limit, a loan interest, and a rate for expense are determined. For example, if an issue having a rating of 70-grade, which is general, the for-each-issue reception order limit is set 100,000 stocks; the loan interest, 3.0%; and the rate of expenses, 1.0. Customers 20 are treated in accordance with the information. If an issue having a rating of 100-grade, which is non-general, the for-each-issue reception order limit is set 1,000,000 stocks; the loan interest, 0%; and the rate of expenses, 0.1 (multiplying factor). If an issue having a rating of 50-grade, the for-each-issue reception order limit is set 10,000 stocks; the loan interest, 24.0%; and the rate of expenses, 10.0.

The for-each-issue reception order limit is the maximum limit of orders that the securities company 1 can receive. As mentioned above, the contracts define to buy the stocks of which stock price rapidly changes to a disadvantageous direction. Thus, for example, upon collapse, if the stocks cannot be sold at the Tokyo Stock Exchange First Section, the issue having a high possibility of buying by the securities company 1 or the like is made have a smaller limit to decrease the risk. On the other hand, if the risk is low, the maximum limit is expanded to get business chances.

For the issue having a low grade with respect to the loan interest and the multiplying factor for expense, a higher cost is set, but for the issue having a high rating, a low cost is set to well treat the customer.

More specifically, there is provided a differentiating section (not shown) for differentiating among the contract conditions including at least one of the trading charge, the interest, the loan stock charge, and expenses received by the securities company 1 by a program in the business computer 11 included in the system adapter 10 or 10′ or the back office computer system 100 or 100′ illustrated in either of FIG. 4, FIG. 12, FIG. 21, or FIG. 16.

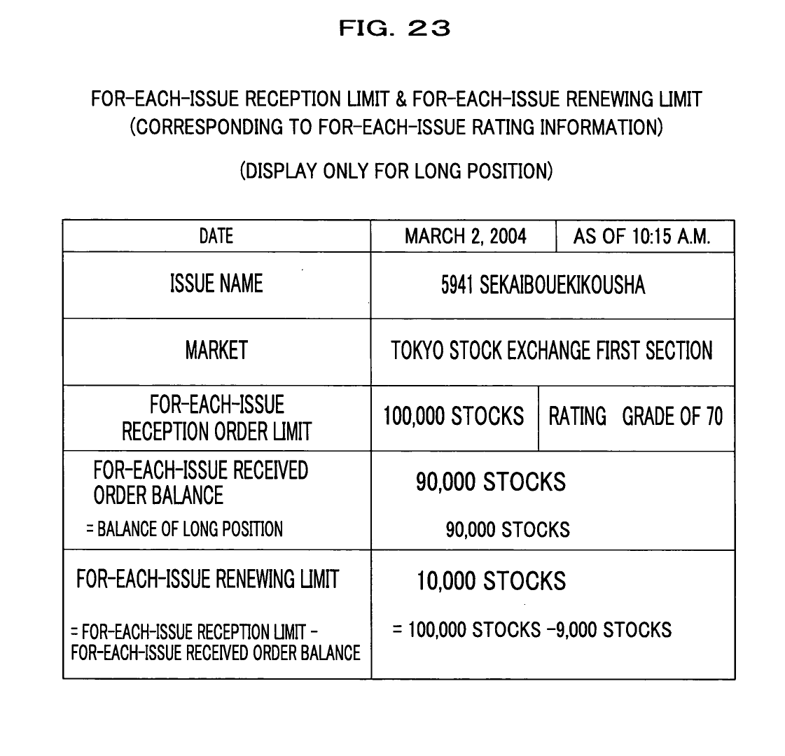

FIG. 23 is an illustration of a display of a for-each-issue reception order limit and a for-each-issue renewing limit only for a long position. That is, FIG. 23 describes the display or an indication for the long position for convenience of explanation, and thus the description for the short position is omitted. FIG. 23 shows an example of a display of the individual rating information read by an employee of the securities company 1 serving a customer. More specifically, the employee searches a piece of individual rating information by operation of the terminal at a shop at 10:15 a.m. on Mar. 2, 2004 to refer to the real time information regarding the for-each-issue reception order receiving limit to provide judging information for trading order from the customer.

As shown in FIG. 23, when the employee or the like of the securities company 1 inputs a code of “5941” as a searching keyword or an issue name “SEKAIBOUEKIKOUSHA”, it has a rating of 70, so that the for-each-issue order reception limit is displayed as 100,000 stocks. Here, the for-each-issue order receiving limit of 100,000 stocks is defined for the issue having a rating of 70-grade for the securities company 1. If the balance of the for-each-issue order reception limit is 90,000 stocks, the remaining is 10,000 stocks and is the reserve force at 10:15 a.m. on Mar. 2, 2004 and referred to as a for-each-issue reception order limit, which is obtained by subtracting the for-each-issue received order balance of 90,000 stocks from the for-each-issue renewing limit of 100,000 stocks.

According to this display, the employee or the like of the securities company 1 can judge instantaneously whether the order from a customer exceeds the for-each-issue reception order limit by comparing the order with the displayed value at the for-each-issue renewing limit to serve the customer properly. This prevents such an erroneous judgment, which may result in missing a business chance due to an excessive reaction for taking an evasive action and the excessive reception of an order exceeding the safe limit. This controls the risk to the securities company 1 by rating the issues having a higher possibility of the closing out by buying by the securities company 1 toward a lower grade as cautionary stocks to properly restrict the for-each-issue reception order limits.

Here, it is ideal to provide a display of a short position (not shown) by short selling together with the long position shown in FIG. 23. In that case, to balance the actual risk covering with business chances using the mutual relation between the balance of the long position and that of the short position, the securities company 1 displays at the for-each-issue renewing limit a reasonable value obtained with a numerical processing using a weighting coefficient equation optionally determined by the securities company 1. Further, the securities company 1 can renew the for-each-issue renewing limit with a suitable value in accordance with its own judgment at a necessary timing to display it.

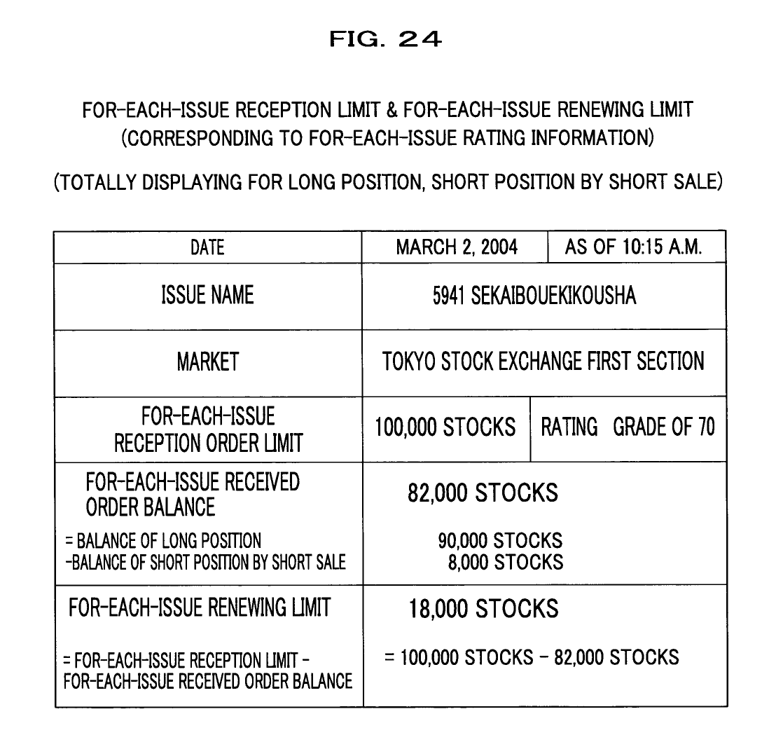

FIG. 24 is an illustration integrally showing the for-each-issue reception order limit provided for individual issue rating information and a long position and a short position by short selling at the for-each-issue renewing limit. Like FIG. 23, inputting the searching code “5941” or the issue name “SEKAIBOUEKIKOUSHA” provides the indication, at the for-each-issue reception order limit, of 100,000 stocks for the issue having a rate grade of 70.

If it is assumed that the for-each-issue received order balance is 82,000 stocks, the 18,000 stocks are the reserve force at 10:15 a.m. on Mar. 2, 2004 and referred to as for-each-issue-renewing limit, wherein the for-each-issue renewing limit is obtained by subtracting the for-each-issue received order balance of 82,000 stocks from the for-each-issue reception order limit of 100,000 stocks.

Here, in the above-mentioned calculation, the for-each-issue order received balance of 82,000 stocks is obtained by subtracting the balance of short position, by short sale, of 8,000 stocks from the balance of the long position of 90,000 stocks.

In addition, there may be necessity to prevent an accident of an excessive order reception due to a miss by an employee of the securities company 1 caused by an excess order exceeding the for-each-issue renewing limit, which should be essentially rejected. For this, an excessive order reception protection function and an excessive order reception alarm display function (not shown) are provided in either of the back office computer system 100 and 100′ or the system adapters 10 and 10′. This perfectly prevents accidents due to excessive ordering and further provides the indication of “rejection due to an excessive order reception” to the customer 20 immediately, which previously avoids a trouble with the customer in default of obligation by the securities company 1 for the request from the customer.

The details of the for-each-issue reception order balance of 98,000 stocks is a total of the current long position of 90,000 stocks and the short position of 8,000 stocks by short selling. However, this display condition may be modified as long as the system 5 can provide information for an instantaneous judgment as to whether the buying order from a customer is allowable such that the maximum allowable limit is restricted by the high risk responsibility, or inversely, the maximum allowable limit is expanded by the low risk responsibility to expand business chance. This is derived by searching the for-each-issue rating information by an employee of the securities company 1 and by referring to the real time information regarding the for-each-issue reception order limit corresponding to the for-each-issue rating information.

In addition, the formats of the stock trading file 12 and the balance sheet 40 are not limited to those shown in the drawings to embody the present invention. Further, if this system 5 has any communication means instead of the Internet 3, it is not always necessary to use the Internet 3.

As mentioned above, the computer system executes a loss cut service for each issue of stocks. On the basis of the trading information shared by the securities company and a customer with which the securities company executes margin trading for lending and renting and/or buying and selling money and stocks using credit accommodation, the computer system manages all open positions or all stocks for specified each open position or each stock and automatically surely executes the loss cut for each open position or each stock, wherein the loss cut is specified to be uniformly executed for all open positions or all stocks within the customer's account in response to input of “a first intra-market selling loss cut specifying rate” and “a second outside market selling loss cut specifying rate.

In other words, the computer system 5 defines an open position to be compulsorily closed out is defined in accordance with a specified profit and loss calculation value out of trading information shared with the customer with which the securities company 1 executes margin trading including loaning money and stocks and buying and selling stocks using credit accommodation. The computer system 5 further stores the transaction content and a renewed stock price. Further, the system 5 provides display (indication) of the open position to be compulsorily closed out and at least one of a stock price of compulsory reverse trading at a market executed by the securities company 1 and a stock price of compulsory reverse trading executed outside the market with a partner including one of the securities company 1 and a party specified by the securities company at a display frame capable of integrally displaying a plurality of open positions at a unit as long as the stocks of the open positions have the same issue, the same trading date, and the same trading price, in order to execute, instead of the customer, automatic loss cut, requested by the customer, for each open position. The system 5 further includes a function for executing the loss cut at a specified rate for each open position at a customer account.

1. A management system comprising:
defining means for defining an open position to be compulsorily closed out in accordance with a specified profit and loss calculation value out of trading information shared with a customer with which a securities company executes margin trading including loaning money and stocks and buying and selling stocks using credit accommodation;
transaction content storing means for storing transaction contents;
stock information collecting means for collecting a renewed stock price;
display means for displaying said open position to be compulsorily closed out and at least one of a stock price of compulsory reverse trading at a market executed by said securities company and a stock price of compulsory reverse trading executed outside said market with a partner including one of said securities company and a party specified by said securities company at a display frame capable of integrally displaying a plurality of open positions at a unit as long as the stocks of said open positions have the same issue, the same trading date, and the same trading price, in order to execute, instead of said customer, an automatic loss cut, requested by said customer, for each open position; and
a function for executing said loss cut at a specified rate for each open position at a customer account.

2. The management system as claimed in claim 1, wherein said margin trading includes short selling.

3. The management system as claimed in claim 1, further comprising:
an interface for directly and indirectly transmitting and receiving information to and from a back office computer system, at said securities company, for executing actual transactions at said market; and
closing out instruction means for transmitting a closing out instruction to said back office computer system of said securities company automatically or manually when said current stock price reaches said stock price at which said compulsory reverse trading at said market is to be executed by said securities company, with excluding customer's feelings.

4. The management system as claimed in claim 1, said management system further comprising:
first instruction means for instructing a back office computer at said securities company for executing actual transactions at said market about execution of compulsory reverse trading at said market for said managed open position when said current stock price reaches said stock price at which said first compulsory reverse trading at the market is to be executed by said securities company.

5. The management system as claimed in claim 4, further comprising second instruction means for instructing said back office computer about said compulsory reverse trading outside the market for said managed open position when said current stock price reaches said stock price at which said compulsory reverse trading outside the market is to be executed by said securities company or a party specified by said securities company.

6. The management system as claimed in claim 5, further comprising:
relative transaction executing means coupled to said second instruction means for executing a relative transaction outside said market using said back office computer system in response to said second instruction means.

7. The management system as claimed in claim 6, further comprising notifying means for notifying a supervisory agent for said market about the execution of said relative transaction, when said relative transaction is executed.

8. The management system as claimed in claim 1, wherein said trading information includes customer identification information, the system further comprising:
identification code generation means for generating an identification code corresponding to said customer;
customer coding means for removing said customer identification information possible to identify the customer from the trading information shared by said securities company and said customer and adding said identification code to said trading information; and
searching and referring means for providing searching and referring said trading information to a third party including said customer with said identification code as a searching mark.

9. The management system as claimed in claim 5, wherein said management system manages a plurality of open positions, said management system further comprising:
given open position totalizing means for selecting given open positions from a plurality of said open positions in accordance with an intention of said customer and totalizing said profit and loss calculation values of said given open positions; and
third instruction means for instructing closing out only said given open positions integrally in accordance with said totalized profit and loss calculation values of said given open positions.

10. The management system as claimed in claim 1, wherein said management system instantaneously manages said open positions for each issue and defines a balance of long positions out of said open positions and a balance of short positions by short selling out of said open positions as a balance of received order for each issue from said customer to said securities company, said management system further comprising:
for-each-issue rating storing means having a searchable function for storing rating for each issue information which is optionally set by said securities company;
for-each-issue reception-order-limit setting means for setting a reception order limit for each issue indicating a limit of received orders of each issue in accordance with at least one of said rating for each issue and optional setting by said securities company; and
renewed limit display means for subtracting a balance of said received order from said reception order limit to generate a renewed limit for each issue and displaying said renewed limit to provide reference of said renewed limit within said securities company.

11. The management system as claimed in claim 10, further comprising differentiating means for differentiating a trading condition for each issue in accordance with rating for each issue information stored in said for-each-issue rating storing means, said trading condition including at least one of a buying and selling charge, an interest, a loan stock charge, and expenses to be collected from a customer by said securities company.

12. The management system as claimed in claim 1, further comprising notifying means for notifying said customer about an indication of said managed open position through the Internet.

13. A held stock management system comprising:
display means for displaying trading information for compulsorily selling, at a loss cut specified stock price, each held stock of which management is requested by said customer, said held stock being purchased by cash trading and unsettled;
transaction content storing means for storing content of a transaction; and
stock price information collecting means for collecting renewed stock price information, wherein said display means displays, at an indication frame capable of integral indication in a unit as long as said held stocks have the same issue, the same transaction day, and the same price, at least one of first indication indicating a first loss cut specifying stock price for instructing compulsorily selling within a market when said renewed stock price exceeds a first decrease rate to act an automatic loss cut for the customer for each stock and a second indication indicating a second loss cut specifying a stock price for instructing compulsorily selling outside said market when said renewed stock price exceeds a second decrease rate to act said automatic loss cut for the customer for each stock, said system further comprising
a loss cut function for effecting said automatic loss cut at said first and second loss cut specified stock prices for each stock in an account of said customer when said renewed stock price exceeds a first decrease rate and when said renewed stock price exceeds a second decrease rate.

14. The held stock management system as claimed in claim 13, further comprising:
an interface for directly and indirectly transmitting and receiving information to and from a back office computer system at said securities company for executing actual transactions at said market;
selling instruction means for transmitting a selling instruction to said back office computer system of said securities company automatically or manually when said renewed stock price reaches a price at which said held stock is to be compulsorily sold by said securities company at the market, excluding customer's feelings.

15. The held stock management system as claimed in claim 13, further comprising:
first instruction means for instructing said back office computer about compulsorily selling said stock at said market when said renewed stock price reaches a price at which said held stock is to be compulsorily sold by said securities company at the market.

16. The held stock management system as claimed in claim 15, further comprising: second instruction means for instructing said back office computer about a compulsory reverse trade outside the market by relative trading for said held stock when said renewed stock price reaches a price at which said held stocks is to be executed by said securities company or a party specified by said securities company.

17. The held stock management system as claimed in claim 16, further comprising: relative trading execution means for executing relative trading outside said market with said back office computer coupled to said second instruction means.

18. The held stock management system as claimed in claim 17, further comprising notifying means for notifying a supervisory agent for said market about the execution of said relative transaction, when said relative transaction is executed.

19. The held stock management system as claimed in claim 13, wherein said trading includes customer identification information, the system further comprising:
identification code generation means for generating an identification code corresponding to said customer;
customer coding means for removing said customer identification information possible to identify the customer from the trading information shared by said securities company and said customer and adding said identification code to said trading information; and
searching and referring means for providing searching and reference of said trading information to a third party including said customer with said identification code as a searching mark.

20. The held stock management system as claimed in claim 14, wherein said management system manages a plurality of held stocks, said management system further comprising:
instruction means for selecting given held stocks from a plurality of said held stocks and instructing about selling only to said given held stocks integrally.

21. The held stock management system as claimed in claim 13, wherein said management system instantaneously manages said held stocks for each issue and defines a balance of stocks as a balance of reception order for each issue received from said customer to said securities company, said management system further comprising:
for-each-issue rating storing means for storing for-each-issue rating information which is optionally set by said securities company in accordance with renewed stock price information for each issue, with a searchable function;
for-each-issue reception-order-limit setting means for setting a reception order limit for each issue indicating a limit of received orders of each issue in accordance with said rating for each issue or an optional setting by said securities company; and
renewed limit display means for subtracting a balance of said reception order from said reception order limit to generate a renewed limit for each issue and displaying said renewed limit to provide reference of said renewed limit within said securities company.

22. The held stock management system as claimed in claim 21, further comprising differentiating means for differentiating a trading condition for each issue in accordance with said for-each-issue rating information stored in said for-each-issue rating storing means, said trading condition including at least one of a buying and selling charge and expenses to be collected from a customer by said securities company.

23. The held stock management system as claimed in claim 13, further comprising notifying means for notifying said customer about an indication of said trading information including a rate of decrease in the held stocks through the Internet.

24. A management system comprising:
display means for displaying an open position subjected to compulsory closing out for each open position, ordered by a customer, out of trading information shared with a customer with which a securities company executes margin trading including loaned money and stocks and buying and selling stocks using credit accommodation;
consignment guarantee money storing means for storing an amount of consignment guarantee money deposited in said securities company by said customer;
transaction content storing means for storing transaction content including an agreed-up price of an open position regarding margin trading depending on money or stock loaned from said securities company by said customer;
stock information collecting means for collecting a renewed stock price;
unrealized profit and loss calculation means for calculating an unrealized profit and loss in accordance with at least one of an unsettled interest, an unsettled loan stock charge, and an unsettled expenses and said trading information including said renewed stock price;
consignment guarantee money maintenance rate calculation means for calculating a consignment guarantee money maintenance rate at a unit of management of open positions of each issue traded on the same day at the same price by substituting values of renewed consignment guarantee money, an agreed-up price of said open position, and unrealized profits and losses for an equation corresponding to said transaction content;
threshold value storing means for storing a threshold value specified regarding said consignment guarantee money maintenance rate for each open position;
managed open position extraction means for extracting a managed open position to be compulsorily closed out from said open positions in an account of said customer when said consignment guarantee maintenance rate reaches said threshold value of consignment guarantee money maintenance rate; and
managed open position display means for displaying said managed open position to be subjected to closing out extracted by said managed open position extraction means with an distinctive indication.

25. The management system as claimed in claim 24, wherein said margin trading includes short selling.

26. The management system as claimed in claim 24, further comprising:
an interface for directly and indirectly transmitting and receiving information to and from a back office computer system at said securities company for executing actual transactions with said market;
closing out instruction means for transmitting a closing out instruction to said back office computer system of said securities company automatically or manually for said managed open position when said consignment guarantee money maintenance rate reaches said threshold value, excluding customer's feelings.

27. The management system as claimed in claim 24, wherein said threshold value comprises a first threshold value for a first compulsory reverse trade at the market and said closing out instruction means comprises first instruction means for instructing said back office computer about said first compulsory reverse trade at the market for said managed open position when said consignment guarantee money maintenance rate reaches said threshold value.

28. The management system as claimed in claim 27, further comprising second instruction means for instructing about a compulsory reverse trading by a relative trading outside said market for said managed open position when said specified consignment guarantee money maintenance rate reaches said threshold value.

29. The management system as claimed in claim 28, further comprising:
relative transaction executing means for executing a relative transaction outside said market using said back office computer system in response to said second instruction means.

30. The management system as claimed in claim 29, further comprising notifying means for notifying a supervisory agent for said market about the execution of said relative transaction, when said relative transaction is executed.

31. The management system as claimed in claim 24, further wherein said trading includes customer identification information, the system comprising:
identification code generation means for generating an identification code corresponding to said customer;
customer coding means for removing said customer identification information possible to identify the customer from the trading information shared by said securities company and said customer and adding said identification code to said trading information; and
searching and referring means for providing searching and referring said trading information to a third party including said customer with said identification code as a searching mark.

32. The management system as claimed in claim 28, wherein said management system manages a plurality of open positions, said management system further comprising:
given open position totalizing means for selecting given open positions from a plurality of said open positions in accordance with an intention of said customer and totalizing said profit and loss calculation values of said given open positions; and
third instruction means for instructing closing out only said given open positions integrally in accordance with said totalized profit and loss calculation values of said given open positions.

33. The management system as claimed in claim 24, wherein said management system instantaneously manages said open positions for each issue and defines a balance of long positions out of said open positions and a balance of short positions by short selling out of said open positions as a balance of received order for each said issue from said customer to said securities company, said management system further comprising:
for-each-issue rating storing means having a searchable function for storing a rating for each issue information which is optionally set by said securities company;
for-each-issue reception-order-limit setting means for setting a reception order limit for each issue indicating a limit of received orders of each issue in accordance with at least one of said rating for each issue and optional setting by said securities company; and
renewed limit display means for subtracting a balance of said received order from said reception order limit to generate a renewed limit for each issue and displaying said renewed limit to provide reference of said renewed limit within said securities company.

34. The management system as claimed in claim 24, further comprising differentiating means for differentiating a trading condition for each issue in accordance with a rating for each issue information stored in said for-each-issue rating storing means, said trading condition including at least one of a buying and selling charge, an interest, a loan stock charge, and expenses to be collected from a customer by said securities company.

35. The management system as claimed in claim 24, further comprising notifying means for notifying said customer about an indication of said managed open position through the Internet.

36. The management system as claimed in claim 1, wherein said display means includes a format for each open position including display areas, for each issue, of: an order type for displaying an order type of an order received from said customer; an account type for displaying an account type of said customer account; a type of open position for displaying a type of said open position; a trading price for displaying an initial trading price of the stocks; a trading date for displaying a trading date, a charge of trading for displaying a charge of the trading; an unrealized profit and loss for displaying an unrealized profit and loss of said stocks; the number of ordered stocks for displaying the number of stocks; a current decrease rate for displaying a current decrease rate of the stocks, a loss cut specified rate for displaying a loss cut specified rate of said open position, a loss cut specified stock price for displaying a loss cut specified stock price of said open position; and a loss cut execution start sign for displaying a sign of the start of execution of loss cut, which are arranged in this order.

37. The management system as claimed in claim 13, wherein said display means includes a balance format for each issue of held stocks including display areas, for each issue, of: an order type for displaying an order type of an order received from said customer; an account type for displaying an account type of said customer account; an issue name of said held stock for displaying said issue name of said held stock; the number of said held stocks for displaying the number of said held stocks; a unit price for displaying an initial trading price of said stocks, a trading date for displaying a trading date; an unrealized profit and loss for displaying an unrealized profit and loss of said stocks; the number of ordered stocks for displaying the number of stocks; a current decrease rate for displaying a current decrease rate of the stocks; a loss cut specified rate for displaying a loss cut specified rate of said held stocks of each issue; a loss cut specified stock price for displaying said loss cut specified stock price of said held stocks of each issue; and a loss cut execution start sign for displaying said sign of the start of execution of loss cut of each issue, which are arranged in this order.
